(19) United States
(12) Patent Application Publication
(10) Pub. No.: US 2026/0167222 A1
(43) Pub. Date: Jun. 18, 2026

(54) ENTERPRISE-ORIENTED CLOUD CONTROL SYSTEM FOR LONG-TAIL CORNER CASES

(71) Applicant: CAVH LLC, Fitchburg, WI (US)

(72) Inventors: Bin Ran, Fitchburg, WI (US); Yuan Zheng, Madison, WI (US); Can Wang, Madison, WI (US); Qiao Yang, Madison, WI (US); Kaijie Luo, Madison, WI (US); Yang Cheng, Middleton, WI (US); Yifan Yao, Madison, WI (US); Jingwen Zhu, Madison, WI (US); Ziwei Yi, Madison, WI (US); Peipei Mao, Madison, WI (US)

(21) Appl. No.: 19/409,995

(22) Filed: Dec. 5, 2025

Related U.S. Application Data
(60) Provisional application No. 63/734,565, filed on Dec. 16, 2024.

(51) Int. Cl. B60W 60/00; B60W 30/18; B60W 50/00; G05B 13/02

(52) U.S. Cl. CPC B60W 60/001; B60W 30/18145; B60W 50/0097; G05B 13/0265; B60W 2540/215; B60W 2554/40; B60W 2555/20; B60W 2556/05; B60W 2556/10; B60W 2556/45

(57) ABSTRACT

An Enterprise-Oriented Cloud Control System is disclosed for providing time-sensitive, vehicle-specific guidance and control instructions to autonomous vehicles (AVs) in long-tail corner cases. The system operates through an enterprise-oriented cloud intelligent unit (E-CIU) that integrates service, management, communication, sensing, prediction, planning, control, and support subsystems. Automated driving scenarios are classified by a traffic fence based on demand and supply characteristics. The E-CIU receives multi-source event and non-event data from vehicles, roads, clouds, and centers, offers various “as-a-service” functions, and employs event models to convert macroscopic event data into microscopic operational data. These models generate cooperative sensing, prediction, planning, and control solutions and produce customized, real-time instructions for longitudinal/lateral motion and operational decisions. An onboard unit exchanges information with the E-CIU and executes cloud-generated commands, providing effective management of AVs in rare and complex scenarios.

### CROSS-REFERENCE TO RELATED APPLICATION

This application claims the benefit of U.S. Provisional Patent Application No. 63/734,565 filed Dec. 16, 2024, which is incorporated by reference herein in its entirety.

### FIELD

Provided herein is technology relating to automated driving and particularly, but not exclusively, to an Enterprise-oriented Cloud Intelligent Unit (E-CIU) that is configured to provide automated driving services for users and, more particularly, to provide users with automated driving applications comprising various services and management.

### BACKGROUND

Autonomous Vehicle (AV), Connected Automated Vehicle (CAV), Connected Automated Road (CAR), and Connected Automated Highway (CAH) systems and methods are in development for facilitating automated driving under certain conditions. However, the developments of AV, CAV, CAR, and/or CAH have not considered the supply and demand of automated driving for providing automated driving services and solutions for a variety of users from the perspective of user optimization. Moreover, the consideration of various types of data, e.g., event data and safety data, for addressing long-tail complex driving scenarios is not adequate.

### SUMMARY

This invention provides systems and methods for an Enterprise-oriented Cloud Intelligent Unit (E-CIU), which facilitates an enterprise to provide automated driving services for the vehicle-cloud collaborative automated driving system (VC-CADS) or vehicle-road-cloud collaborative automated driving system (VRC-CADS). The E-CIU system comprises eight subsystems and provides eight functions at various spatial-temporal levels through multi-resources integration and allocation to support automated driving service and remote service. Additionally, the E-CIU subsystems and methods provide solutions for various corner cases and long-tail cases using event models with multi-data sources.

In some embodiments, the E-CIU technology improves and/or extends particular cloud system design, cloud platform design, service application, and users, e.g., the Collaborative Automated Driving System (CADS) technology and related technologies described in U.S. Pat. Nos. 10,380,886, 10,692,365, 12,008,893, 11,495,126, 12,057,011, 12,037,023, 12,002,361, and U.S. Patent Application Ser. Nos. 63/120,075, filed on Dec. 1, 2020, Ser. No. 17/840,237, filed on Jun. 14, 2022, Ser. No. 17/840,249, filed on Jun. 14, 2022, and Ser. No. 17/873,660, filed on Jul. 26, 2022, the disclosure of each of which is herein incorporated by reference in its entirety. In particular, in some embodiments, the E-CIU technology provides an enterprise-oriented cloud intelligent unit architecture comprising a sensing subsystem, a prediction subsystem, a planning and decision-making subsystem, a control subsystem, an integration and allocation subsystem, a service and management subsystem, a communication subsystem, and a supporting subsystem. In some embodiments, the E-CIU technology extends management of said CADS to service applications, including basic automated driving travel service, advanced automated driving travel service, automated driving application value-added service, remote service, operational service, maintenance service, and information service. In some embodiments, the E-CIU technology extends the cloud subsystem of said CADS to a hierarchy of clouds comprising the central cloud, fog cloud, and edge cloud. In some embodiments, the E-CIU technology specifies the users, which include automobile companies, suppliers, technology companies, vehicles, roads, travelers, and clouds.

In some embodiments, the E-CIU technology improves and/or extends specific automated driving technologies and users, e.g., the Connected Automated Vehicle Highway (CAVH) technology and related technologies described in, e.g., U.S. Pat. Nos. 10,380,886; 11,482,102; 11,955,022; 10,867,512; and/or 10,692,365, each of which is incorporated herein by reference. In particular, in some embodiments, the E-CIU specifies the serviced user as enterprise-orientated compared with that of the CAVH and extends its service to automobile companies, suppliers, technology companies, vehicles, roads, travelers, and clouds. In some embodiments, the E-CIU technology provides an enterprise-orientated cloud intelligent unit configured to extend the CAVH subsystem and add additional functions to the CAVH technology through subsystem and component design scheme of the E-CIU and the integration and allocation of functions, intelligence, and equipment.

In some embodiments, the E-CIU technology improves and/or extends specific cloud platform design, and service and management applications, e.g., the Intelligent Road Infrastructure System (IRIS) described in, e.g., U.S. Pat. Nos. 10,692,365, which is incorporated herein by reference. In particular, in some embodiments, the E-CIU technology extends the cloud platform to a cloud intelligent unit architecture, comprising a sensing subsystem, a prediction subsystem, a planning and decision-making subsystem, a control subsystem, an integration and allocation subsystem, a service and management subsystem, a communication subsystem, and a supporting subsystem, and a hierarchy of clouds comprising the central cloud, fog cloud, and edge cloud. In some embodiments, the E-CIU system includes a service and management subsystem, a communication subsystem, a sensing subsystem, a prediction subsystem, a planning and decision subsystem, a control subsystem, an integration and allocation subsystem, and a supporting subsystem. In some embodiments, the E-CIU technology adds information services to the cloud system, especially the Information as a Service (IaaS) and Artificial Intelligence as a Service (AIaaS). In some embodiments, the E-CIU technology supplements the service in the application, including basic automated driving travel services, advanced automated driving travel services, automated driving application value-added services, remote services, operational service, maintenance service, and information service.

In some embodiments, the E-CIU technology improves and/or extends specific users and services, and it classifies automated driving scenarios by a traffic fence. In particular, in some embodiments, e.g., the cloud-based technology for Connected and Automated Vehicle Highway System (CAVH) described in, e.g., U.S. Pat. No. 12,057,011, which is incorporated herein by reference. In particular, in some embodiments, the E-CIU specifies the users as enterprise orientated users and extends to enterprises, E-CIU subsystems and components, travelers, and clouds. In some embodiments, the E-CIU extends services, including Computing as a Service (CaaS), Information as a Service (IaaS), Sensing as a Service (SEaaS), Operation and Maintenance as a Service (OMaaS), and Artificial Intelligence as a Service (AIaaS). In some embodiments, the E-CIU classifies automated driving scenarios through a traffic fence comprising demand characteristics and supply characteristics.

In some embodiments, an enterprise refers to a type of profit-making organization that provides services related to automated driving for users and/or individual travelers. These enterprises not only encompass traditional vehicle manufacturers and technology companies, but also include providers of automated driving transportation services, suppliers of automated driving technology solutions, component and sensor suppliers, as well as companies offering backend support and cloud services for automated driving.

In some embodiments, the E-CIU comprises one or more of (1) Service and management subsystem, (2) Communication subsystem, (3) Sensing subsystem, (4) Prediction subsystem, (5) Planning and decision making subsystem, (6) Control subsystem, (7) Integration and allocation subsystem, and (8) Supporting subsystem. In some embodiments, the E-CIU type includes but not limited to sensing-centric E-CIU, position-centric E-CIU, prediction-centric E-CIU, planning and decision making-centric E-CIU, control-centric E-CIU, integration and allocation-centric E-CIU, basic E-CIU, and advanced E-CIU, comprising different combinations of subsystems.

In some embodiments, the development cycle of an E-CIU ranges from 3 months to 12 months, or shorter. The development speed or iteration speed of an E-CIU is faster than the infrastructure-related intelligent units and road-related intelligent units.

In some embodiments, the E-CIU provides functions including but not limited to sensing, prediction, decision, planning, control, service, management, operation, and maintenance.

In some embodiments, the E-CIU provides positioning and multi-dimensional sensing functions through utilizing CAVs' and/or AVs' sensors, road sensors, and/or cloud computing modules. In some embodiments, the E-CIU provides multi-level prediction functions for CAVs and/or AVs through sensing information of the E-CIU.

In some embodiments, the E-CIU provides vehicle control functions through sensing, prediction, planning and decision-making information to generate vehicle control commands.

In some embodiments, the E-CIU provides a traffic fence, which is configured to classify automated driving scenarios based on demand and supply characteristics. In some embodiments, the demand characteristic is the request generated by the demand side of automated driving service and the supply characteristic is resources and powers on the computing, storage, and other functions that E-CIU subsystems and components can provide.

In some embodiments, the spatial-temporal level of the traffic fence and automated driving services comprises both the temporal dimension and the spatial dimension at microscopic, mesoscopic, and macroscopic levels.

In some embodiments, the single-source or multi-source input data of E-CIU includes event and/or non-event data obtained from one or more of vehicles, roads, clouds, and centers. In some embodiments, the event data includes work zone data, weather data, traffic control devices data, incident data, activity data, and near miss data. In some embodiments, the non-event data includes traffic flow data, vehicle dynamics data, traveler demand data, and system calculation and storage resource data.

In some embodiments, the E-CIU provides Storage as a Service (STaaS), Control as a Service (CCaaS), Computing as a Service (CaaS), Information as a Service (IaaS), Sensing as a Service (SEaaS), Operation and Maintenance as a Service (OMaaS), and Artificial Intelligence as a Service (AIaaS).

In some embodiments, the AIaaS is configured to provide one or more of an automated driving database, AI model training and download, and an AI foundation model framework to provide AI computing services together with the cloud computing module. In some embodiments, the AIaaS is configured to meet specific demands of automated driving service. In some embodiments, the AIaaS provides an AI foundation model framework comprising an AI platform for AI computing and an AI modeling framework for automated driving functions and services.

In some embodiments, the E-CIU provides vehicle control functions including one or more of single-vehicle control methods, platoon control methods, and cooperative control methods.

In some embodiments, the E-CIU provides high-precision, low-latency communication and network services between the subsystems and/or components of the E-CIU and the user through a variety of wired or wireless communication modes.

In some embodiments, the E-CIU realizes the integration and allocation of functions, resources, and information flow of subsystems and/or components of E-CIU in sensing, prediction, planning, decision making, and control; and it realizes collaborative sensing, collaborative prediction, collaborative planning and decision-making, and collaborative control through the functional integration, optimization, and centralized deployment of existing resources.

In some embodiments, the E-CIU is configured to provide cloud computing based on one or more of the central cloud, fog cloud, and edge cloud.

In some embodiments, the E-CIU is configured to provide a combined solution of subsystems and/or components of E-CIU to meet specific demands of automated driving service based on the automated driving AI database and cloud-based computing.

In some embodiments, the E-CIU provides one or more automated driving services to different users according to requirements; said automated driving service includes travel services, value-added services of automated driving applications, remote service, operational service, and maintenance service.

In some embodiments, the automated driving travel service herein includes basic automated driving travel service and advanced automated driving travel service. In some embodiments, basic automated driving travel service is configured to provide basic travel service of automated driving and remote service at various levels (primarily microscopic-level) to CAVs and/or AVs according to personalized travel requirements, traffic flow conditions, and traffic management regulations. In some embodiments, advanced automated driving travel services are configured to provide advanced travel service of automated driving and remote service at various levels (primarily microscopic-level) to CAVs and/or AVs to maximize personalized requirements of CAVs and/or AVs according to the travel requirements, traffic flow conditions, and traffic management regulations.

In some embodiments, the E-CIU provides remote services, including remote monitoring, remote driving, and remote rescue.

In some embodiments, the E-CIU is configured to provide remote services in either a request response mode or a forced-provision mode according to the emergency of the scenarios.

In some embodiments, the E-CIU provides eight functions, including enhancement, complement, backup, elevation, replacement, monitoring, operation, and maintenance functions to system components to support automated driving.

In some embodiments, the application value-added service module of E-CIU described herein is configured to analyze the life cycle quality of vehicles. In some embodiments, the application value-added service module of E-CIU described herein is configured to analyze the driving conditions of an individual or group of vehicles. In some embodiments, the application value-added service module of E-CIU described herein is configured to analyze the demand of vehicle pre-sales and after-sales.

In some embodiments, the vehicle operation management module of E-CIU described herein is configured to provide microscopic-level and mesoscopic-level prediction information, planning and decision-making strategies, and/or control instructions.

In some embodiments, the event response module of E-CIU described herein is configured to provide automated driving solutions based on the analysis of various events. In some embodiments, the event response module of E-CIU described herein is configured to customize management and control solutions for CAVs and/or AVs to address various long-tail scenarios to improve the ability of users to solve various long-tail scenario problems.

In some embodiments, the operation module and maintenance module provide the full life cycle operation of E-CIU and the full life cycle maintenance of users and software and/or hardware equipment of E-CIU. In some embodiments, the full life cycle operation includes the design phase, manufacturing and testing phase, operation phase, and upgrading phase.

In some embodiments, the multi-engine modules of E-CIU described herein are configured as sensing engine, prediction engine, decision making and planning engine, execution engine, operations engine, maintenance engine, and/or supporting engine.

In some embodiments, the E-CIU provides collaboration among subsystems with different levels of intelligence, and integrates and optimizes the cloud resources, including sensing resources, computing resources, and storage resources, for enhancing the intelligence level of the overall system through the integration functions. In some embodiments, the E-CIU provides collaborative sensing, collaborative prediction, collaborative planning and decision making, and collaborative control based on system demand under complex traffic environments through the centralized deployment of cloud functions and computing power for virtual sensing prediction, decision-making and planning, control, etc.

In some embodiments, the cooperative operation method of E-CIU described herein is configured to combine with AVs, CAVs, CAHs, and/or CARs. In some embodiments, the intelligence level of AVs or CAVs can be elevated through its combination with E-CIU, CAHs, and/or CARs. In some embodiments, the collaborative operation method is configured to be used to provide automated driving travel services, automated driving application value-added services, remote service, operational service, and maintenance service.

### BRIEF DESCRIPTION OF THE DRAWINGS

These and other features, aspects, and advantages of the present technology will become better understood with regard to the following drawings.

FIG. 1 is a schematic drawing showing the components of the Enterprise-oriented Cloud Intelligent Unit (E-CIU). 101: E-CIU. 102: Service and management subsystem. 103: Communication subsystem. 104: Sensing subsystem. 105: Prediction subsystem. 106: Planning and decision making subsystem. 107: Control subsystem. 108: Integration and allocation subsystem. 109: Supporting subsystem.

FIG. 2 is a schematic drawing showing the data source of the E-CIU. 201: E-CIU. 202: Data source. 203: Event data. 204: Non-event data. 205: Data sent to E-CIU.

FIG. 3 is a schematic drawing showing the users of the E-CIU. 301: E-CIU. 302: Services provided by E-CIU. 303: users.

FIG. 4 is a schematic drawing showing the hardware equipment of the E-CIU. 401: E-CIU. 402: Hardware equipment of E-CIU. 403: Storage devices. 404: Computing devices. 405: Communication devices. 406: Supporting devices.

FIG. 5A is a schematic drawing showing the levels of cloud of the E-CIU. 501: E-CIU. 502: Central cloud. 503: Fog cloud. 504: Edge cloud. 505: Data sent from central cloud to fog cloud. 506: Data sent from fog cloud to central cloud. 507: Data sent from fog cloud to edge cloud. 508: Data sent from edge cloud to fog cloud.

FIG. 5B is a schematic drawing showing an embodiment of the levels of cloud of the E-CIU. 501: E-CIU. 502: Central cloud. 504: Edge cloud. 509: Data sent from central cloud to edge cloud. 510: Data sent from edge cloud to central cloud.

FIG. 6 is a schematic drawing showing an example of the applications of the E-CIU. 601: E-CIU applications. 602: Service. 603: Management.

FIG. 7 is a schematic drawing showing the components of the AI foundation model framework. 701: AI foundation model framework. 702: AI platform. 703: AI modeling framework. 704: The AI platform provides AI computing. 705: The AI modeling framework provides AI model. 706: AI computing. 707: AI model.

FIG. 8 is a flow chart showing an example embodiment of the E-CIU sensing subsystem.

FIG. 9 is a flow chart showing an example embodiment of the E-CIU prediction subsystem.

FIG. 10 is a flow chart showing an example embodiment of the E-CIU planning and decision making subsystem.

FIG. 11 is a flow chart showing an example embodiment of the E-CIU control subsystem.

FIG. 12 is a flow chart showing an exemplary embodiment of the E-CIU's integration module.

FIG. 13 is a flow chart showing an exemplary embodiment of the E-CIU's basic automated driving travel service module and advanced automated driving travel service module.

FIG. 14 is a flow chart showing an exemplary embodiment of the E-CIU's automated driving application value-added service module.

FIG. 15 is a schematic drawing showing the workflow of the E-CIU's event model.

FIG. 16 is a flow chart showing an exemplary embodiment of the advanced E-CIU operation method.

FIG. 17 is a flow chart showing an exemplary embodiment of the cooperative operation method of E-CIU.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

Provided herein is technology relating to automated driving and particularly, but not exclusively, to an Enterprise-oriented Cloud Intelligent Unit (E-CIU) that is configured to provide automated driving services for users and, more particularly, to provide automated driving services for single CAV and/or AV by sending individual vehicle with detailed and time-sensitive control instructions for lateral and longitudinal movement of vehicles, including vehicle following, lane changing, route guidance, and related information. In some embodiments, the E-CIU is configured to provide users with automated driving services, including basic automated driving travel service, advanced automated driving travel service, automated driving application value-added service, remote service, operational service, and maintenance service.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belong. When definitions of terms in incorporated references appear to differ from the definitions provided in the present teachings, the definition provided in the present teachings shall control. The section headings used herein are for organizational purposes only and are not to be construed as limiting the described subject matter in any way.

### Definitions

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, disclosure of ranges includes disclosure of all values and further divided ranges within the entire range, including endpoints and sub-ranges given for the ranges.

As used herein, the suffix “.free” refers to an embodiment of the technology that omits the feature of the base root of the word to which “-free” is appended. That is, the term “X.free” as used herein means “without X”, where X is a feature of the technology omitted in the “X.free” technology. For example, a “calcium free” composition does not comprise calcium, a “mixing-free” method does not comprise a mixing step, etc.

Although the terms “first”, “second”, “third”, etc. may be used herein to describe various steps, elements, compositions, components, regions, layers, and/or sections, these steps, elements, compositions, components, regions, layers, and/or sections should not be limited by these terms unless otherwise indicated. These terms are used to distinguish one step, element, composition, component, region, layer, and/or section from another step, element, composition, component, region, layer, and/or section. Terms “first”, “second”, and other numerical terms when used herein do not imply a sequence or order unless clearly indicated by the context. Thus, a first step, element, composition, component, region, layer, or section discussed herein could be termed a second step, element, composition, component, region, layer, or section without departing from technology.

As used herein, the term “presence” or “absence” (or, alternatively, “present” or “absent”) is used in a relative sense to describe the amount or level of a particular entity (e.g., component, action, element). For example, when an entity is said to be “present”, it means the level or amount of this entity is above a pre-determined threshold; conversely, when an entity is said to be “absent”, it means the level or amount of this entity is below a pre determined threshold. The pre determined threshold may be the threshold for detectability associated with the particular test used to detect the entity or any other threshold. When an entity is “detected” it is “present”; when an entity is “not detected” it is “absent”.

As used herein, the term “increase” or a “decrease” refers to a detectable (e.g., measured) positive or negative change, respectively, in the value of a variable relative to a previously measured value of the variable, relative to a pre-established value, and/or relative to a value of a standard control. An increase is a positive change preferably at least 10%, more preferably 50%, still more preferably 2-fold, even more preferably at least 5-fold, and most preferably at least 10-fold relative to the previously measured value of the variable, the pre-established value, and/or the value of a standard control. Similarly, a decrease is a negative change preferably at least 10%, more preferably 50%, still more preferably at least 80%, and most preferably at least 90% of the previously measured value of the variable, the pre-established value, and/or the value of a standard control. Other terms indicating quantitative changes or differences, such as “more” or “less,” are used herein in the same fashion as described above.

As used herein, the term “number” shall mean one or an integer greater than one (e.g., a plurality).

As used herein, the term “system” refers to a plurality of real and/or abstract components operating together for a common purpose. In some embodiments, a “system” is an integrated assemblage of hardware and/or software components. In some embodiments, each component of the system interacts with one or more other components and/or is related to one or more other components. In some embodiments, a system refers to a combination of components and software for controlling and directing methods. For example, a “system” or “subsystem” may comprise one or more of, or any combination of, the following: mechanical devices, hardware, components of hardware, circuits, circuitry, logic design, logical components, software, software modules, components of software or software modules, software procedures, software instructions, software routines, software objects, software functions, software classes, software programs, files containing software, etc., to perform a function of the system or subsystem. Thus, the methods and apparatus of the embodiments, or certain aspects or portions thereof, may take the form of program code (e.g., instructions) embodied in tangible media, such as floppy diskettes, CD-ROMs, hard drives, flash memory, or any other machine-readable storage medium wherein, when the program code is loaded into and executed by a machine, such as a computer, the machine becomes an apparatus for practicing the embodiments. In the case of program code execution on programmable computers, the computing device generally includes a processor, a storage medium readable by the processor (e.g., volatile and non-volatile memory and/or storage elements), at least one input device, and at least one output device. One or more programs may implement or utilize the processes described in connection with the embodiments, e.g., through the use of an application programming interface (API), reusable controls, or the like. Such programs are preferably implemented in a high-level procedural or object-oriented programming language to communicate with a computer system. However, the program(s) can be implemented in assembly or machine language, if desired. In any case, the language may be a compiled or interpreted language, and combined with hardware implementations.

As used herein, the term “Automated Driving System” (abbreviated “ADS”) refers to a system that performs driving tasks (e.g. lateral and longitudinal control of the vehicle) for a vehicle and thus allows a vehicle to drive with reduced human control of driving tasks and/or without human control of driving tasks.

As used herein, the term “Intelligent Driving” refers to a vehicular operational paradigm in which the vehicle assumes the role of a cognizant collaborator to the operator. Within this paradigm, the vehicle is equipped with an integrated network of image-capturing devices, sensory detectors, and computational regulators that cohesively function to discern potential hazards within the vehicular environment. The system is configured to proffer an assortment of notifications to the driver, which may manifest in visual, auditory, or tactile forms. The foundation of this system is predicated on the sophisticated synthesis of data procured from the cameras, sensors, and control units, ensuring an elevated echelon of vehicular safety and driver assistance.

As used herein, the term “Human Driving Vehicle” (abbreviated “HDV”) refers to any motorized vehicle primarily controlled by a human driver through manual inputs such as steering, braking, and acceleration. HDVs may include traditional combustion engine vehicles, electric vehicles, and hybrids that do not possess the capabilities to drive autonomously or semi-autonomously beyond basic driver assistance systems such as cruise control. These vehicles require direct and continuous input from a human operator to navigate and interact with the driving environment, notwithstanding the presence of supplementary systems designed to assist the driver in maintaining safety and comfort.

As used herein, the term “Operational Design Domain” (abbreviated “ODD”) refers to the operating conditions under which a given automated driving system and/or feature thereof is specifically designed to function, including, but not limited to, characteristics and/or restrictions related to environmental, geographical, and/or time-of-day factors, and/or related to the presence or absence of certain traffic or roadway characteristics. In some embodiments, the ODD is defined by SAE International Standard J3016, “Taxonomy and Definitions for Terms Related to Driving Automation Systems for On-Road Motor Vehicles” (J3016_201806), which is incorporated herein by reference.

As used herein, the term “Connected Automated Vehicle Highway System” (“CAVH System”) refers to a comprehensive system (e.g., an ADS) providing full vehicle operations and control for connected and automated vehicles (CAV), and, more particularly, to a system controlling CAVs by sending individual vehicles with detailed and time-sensitive control instructions for vehicle following, lane changing, route guidance, and related information. A CAVH system comprises sensing, communication, and control components connected through segments and nodes that manage an entire transportation system. CAVH systems comprise four control levels or components: vehicle; roadside unit (RSU), which, in some embodiments, is similar to or the same as a roadside intelligent unit (RIU); traffic control unit (TCU); and traffic control center (TCC). See U.S. Pat. Nos. 10,380,886; 11,482,102; 11,955,022; 10,867,512; and/or 10,692,365, each of which is incorporated herein by reference.

As used herein, the term “Intelligent Road Infrastructure System” (abbreviated as “IRIS”) refers to a system that facilitates vehicle operations and control for CAVH systems. See U.S. Pat. Nos. 10,867,512, 10,692,365, 11,430,328, and/or 11,854,391 each of which is incorporated herein by reference. In some embodiments, an IRIS further comprises a cloud component. In some embodiments, an IRIS provides transportation management and operations and individual vehicle control for autonomous vehicles (AVs). For example, in some embodiments, an IRIS provides a system for controlling AVs by sending individual vehicles with customized, detailed, and time-sensitive control instructions and traffic information for automated vehicle driving (vehicle following, lane changing, route guidance, and other related information).

As used herein, the term “Intelligence Allocation” refers to systems and methods that allocate, arrange, and distribute certain types of functions and intelligence, for connected automated vehicle highway (CAVH) systems or ADS, to facilitate vehicle operations and controls, to improve the general safety of the transportation system, and to ensure the efficiency, intelligence, reliability, and resilience of CAVH systems or ADS. The present invention also provides methods to define CAVH system intelligence and its levels, which are based on two dimensions: the vehicle intelligence and infrastructure intelligence. See U.S. Pat. Nos. 11,495,126, which is incorporated herein by reference.

As used herein, the term “event model” refers to any method, algorithm, framework or service that collects, processes, interprets, renders, decodes, encodes, fuses, predicts, determines, disperses, distributes, allocates, integrates, controls, manages, optimizes and providing information, intelligence and/or control instructions about an event that is affecting or will affect the operations of an automated driving system or any of its components. Examples of an event include, but not limited to, severe weather, work zone, poor lighting, porthole of pavement, slippery pavement, lane closures, traffic congestion, traffic control, restriction, emergency vehicles, sporting events, concerts, and traffic incidents.

As used herein, the term “Collaborative Automated Driving System” or “CADS” refers to the technology which provides improved CAVH technologies or ADS technologies (e.g., CAVH systems, components of CAVH systems, CAVH methods, and related CAVH functionalities) by enhancing the CAVH subsystem design scheme and adding further subsystems and algorithms to the CAVH technology. The CADS comprises: 1) a cooperative management subsystem; 2) a road subsystem; 3) a vehicle subsystem; 4) a communication subsystem; 5) a user subsystem; and/or 6) a supporting subsystem. Importantly, embodiments of the CADS technology described herein provide a comprehensive solution for implementing CAVH technologies more efficiently in a broad variety of different operational design domains using a system level binding method. In some embodiments, the CADS optionally comprises a cloud subsystem and/or a map subsystem. In some embodiments, the CADS is configured to provide transportation management. In some embodiments, the CADS is configured to provide full vehicle operations and control for connected automated vehicle and highway systems by sending individual vehicles with detailed and time-sensitive control instructions for vehicle operations. See U.S. patent application Ser. No. 17/667,683, which is incorporated herein by reference.

As used herein, the term “Cooperative Driving Automation” (abbreviated as “CDA”) refers to technology that supports and enables automated vehicles to cooperate through communication between vehicles, infrastructure devices capable of communication, and road users, such as pedestrians, bicyclists, and scooters. The CDA is defined in SAE International Standard J3216_202005, “Taxonomy and Definitions for Terms Related to Cooperative Driving Automation for On-Road Motor Vehicles” (published in 2020 (J3216_202005), which is incorporated herein by reference). The cooperation supports or enables performance of the dynamic driving task (DDT) for a subject vehicle with driving automation feature(s) engaged. Other participants may include other vehicles with driving automation feature(s) engaged, shared road users (e.g., drivers of manually operated vehicles or pedestrians or cyclists carrying personal devices), or road operators (e.g., those who maintain or operate traffic signals or workzones). CDA is defined in J3216 as having four classes of cooperation, A through D, with an increasing amount of cooperation associated with each successive class:
Class A: Status-sharing.
Class B: Intent-sharing.
Class C: Agreement-seeking.
Class D: Prescriptive.

Information shared among CDA participants can directly influence the dynamic driving task (DDT) by one or more nearby vehicles with driving automation feature(s) engaged. Ultimately, CDA-enabled cooperation can facilitate the safer and more efficient movement of road users, which can significantly improve the overall performance of the transportation system—and at lower cost than traditional methods. The CAVH or CADS are advanced versions of CDA.

As used herein, the term “CDA component” or “component of an CDA” refers individually and/or collectively to one or more of components of an CDA and/or a CAVH system, e.g., an AV, CAV, OBU, VIU, RSU, RIU, TCC, TCU, TCU, TOC, a supporting subsystem, and/or a cloud component.

As used herein, the term “Vehicle-Road-Cloud system” (abbreviated as “VRC system”) refers to an automated driving system, which is a distributed and integrated ADS with a vehicle component, a road component, and a cloud component. For example, a VRC system could be a CAVH system, an IRIS system, or a CDA system.

As used herein, the term “Vehicle-Edge-Cloud system” (abbreviated as “VEC system”) refers to an automated driving system, which is a distributed and integrated ADS with a vehicle component, an edge cloud component, and a central cloud component. For example, a VEC system could be a CAVH system, an IRIS system, a VRC system, or a CDA system.

As used herein, the term “Vehicle-Cloud system” (abbreviated as “VC system”) refers to an automated driving system, which is a distributed and integrated ADS with a vehicle component and a cloud component. For example, a VC system could be a CAVH system, an IRIS system, or a CDA system.

As used herein, the term “vehicle” refers to any type of powered transportation device, which includes, and is not limited to, an automobile, truck, bus, motorcycle, or boat. The vehicle may normally be controlled by an operator or may be unmanned and remotely or autonomously operated in another fashion, such as using controls other than the steering wheel, gear shift, brake pedal, and accelerator pedal.

As used herein, the term “road system” or “road” or “roadside system” refers to roads and to road infrastructure, e.g., intelligent road infrastructure (e.g., IRIS, IRT, RIU/RSU), road signs, road markings, traffic control devices (e.g., traffic signal controller); and/or conventional traffic operations centers.

As used herein, the term “automated vehicle” or “autonomous vehicle” (abbreviated as “AV”) refers to an automated vehicle in an automated mode, encompassing at any level of automation (e.g., as defined by SAE International Standard J3016, “Taxonomy and Definitions for Terms Related to Driving Automation Systems for On-Road Motor Vehicles” (published in 2014 (J3016_201401) and as revised in 2016 (J3016_201609) and 2018 (J3016_201806), each of which is incorporated herein by reference)).

As used herein, the term “connected vehicle” or “CV” refers to a connected vehicle, e.g., configured for any level of communication (e.g., V2V, V2I, and/or I2V).

As used herein, the term “connected and autonomous vehicle” or “connected and automated vehicle” or “CAV” refers to an autonomous vehicle capable of communicating with other vehicles (e.g., via V2V communication), with roadside units (RSU) or roadside intelligent units (RIU), traffic control signals, and/or other infrastructure (e.g., an ADS or component thereof) or devices. That is, the term “CAV” refers to a connected autonomous vehicle having any level of automation (e.g., as defined by SAE International Standard J3016 (2014)) and communication (e.g., V2V, V2I, and/or I2V). AV, as used herein, is a broad term that includes CV and CAV, meaning an autonomous vehicle may have communication capabilities, thus qualifying as a CV or CAV.

As used herein, the term “On-board Unit” (“OBU”) refers to a vehicle on-board device configured to provide transportation management and operations and vehicle control for CAV in coordination with an IRIS or CAVH, and, more particularly, to a system for controlling CAVs by sending customized, detailed, and time-sensitive control instructions and traffic information for automated driving to individual vehicles, such as vehicle following, lane changing, route guidance, and other related information. See U.S. patent application Ser. No. 16/505,034, which is incorporated herein by reference.

As used herein, the term “Vehicle Intelligent Unit” (“VIU”) refers to an interface configured to provide vehicle operations and control for CAV and, more particularly, to an interface configured to connect with a Collaborative Automated Driving System (CADS) and manage and/or control information exchange between CAV and CADS and manage and/or control CAV lateral and longitudinal movements, including vehicle following, lane changing, and route guidance. See U.S. patent application Ser. No. 17/718,443, which is incorporated herein by reference.

As used herein, the term “Roadside Intelligent Unit” (abbreviated “RIU”) may refer to one RIU, a plurality of RIU, and/or a network of RIU.

As used herein, the term “configured” refers to a component, module, system, subsystem, etc. (e.g., hardware and/or software) that is constructed and/or programmed to carry out the indicated function.

As used herein, the terms “determine,” “calculate,” “compute,” and variations thereof, are used interchangeably to any type of methodology, processes, mathematical operation, or technique.

As used herein, the term “GPS” refers to a global navigation satellite system (GNSS) that provides geolocation and time information to a receiver. Examples of a GNSS include, but are not limited to, the Global Positioning System developed by the United States, Differential Global Positioning System (DGPS), BeiDou Navigation Satellite System (BDS) System, GLONASS Global Navigation Satellite System), European Union Galileo positioning system, the NavIC system of India, and the Quasi-Zenith Satellite System (QZSS) of Japan.

As used herein, the term “artificial intelligence model” (or “AI model”) refers to a program that has been trained on a set of data to recognize certain patterns or make certain decisions without further human intervention. AI models apply different algorithms to relevant data inputs to achieve the tasks, or output, that they've been programmed for. An AI model is defined by its ability to autonomously make decisions or predictions, rather than simulate human intelligence. In some embodiments, the AI models comprise machine learning models and learning-based models.

As used herein, the term “Foundation Model” or “FM” refers to a classification of deep learning neural network architectures which are trained upon expansive datasets to serve as a primary, versatile framework for further AI applications. These Foundation Models are distinguished by their extensive training on a vast and generalized corpus of data, which may be unstructured and unlabeled, enabling the model to execute a broad array of tasks. The utility of FMs lies in their ability to function as a baseline from which specialized machine learning (ML) models can be derived with increased efficiency and reduced development costs. Foundation Models are capable of processing and understanding multiple forms of input, including but not limited to natural language text, image data, and conversational dialects, thereby facilitating their application across a wide spectrum of AI-driven functionalities.

As used herein, the term “computing platform” refers to an integrated system of hardware and software components that provides the necessary computational capabilities to develop, train, deploy, and manage AI models. This platform may consist of specialized processors such as GPUs (Graphics Processing Units), TPUs (Tensor Processing Units), and high-performance CPUs (Central Processing Units), alongside the requisite memory, storage, and networking infrastructure. The computing platform may be configured to operate in various environments, including but not limited to, cloud-based services, distributed computing systems, edge computing nodes, and standalone workstations.

As used herein, the term “cloud” within the context of a Connected Automated Vehicle Highway (CAVH) system or ADS system refers to a structured, tiered architecture composed of edge, fog, regional, and central clouds. Each level is designed to fulfill specific roles tailored to the operational demands of the CAVH system. The edge cloud or edge computing node (abbreviated as “edge”) operates at the closest proximity to vehicular and roadside units, facilitating real-time data processing and immediate decision making for individual vehicles and local infrastructure. The regional cloud or fog cloud provides intermediate-level data integration and analytics, focusing on broader area traffic management and coordination between multiple edge clouds to optimize regional traffic flows and infrastructure usage. Finally, the central cloud oversees overarching functions such as high-level traffic planning, large-scale data analytics, and overall system control, integrating inputs from the regional clouds to enhance the efficiency and safety of the entire transportation network. See U.S. Pat. Nos. 12,057,011; and/or U.S. patent application Ser. No. 17/779,372, each of which is incorporated herein by reference.

As used herein, the term “support” when used in reference to one or more components of an ADS, CAVH, CADS, CAV, and/or a vehicle providing support to and/or supporting one or more other components of the ADS, CAVH, CADS, CAV, AV, CV, HDV, and/or a vehicle refers to, e.g., exchange of information and/or data between components and/or levels of the ADS, CAVH, CADS, CAV, and/or a vehicles; sending and/or receiving instructions between components and/or levels of the ADS, CAVH, CADS, CAV, and/or a vehicle; and/or other interaction between components and/or levels of the ADS, CAVH, CADS, CAV, and/or a vehicle that provide functions such as information exchange, data transfer, messaging, and/or alerting.

As used herein, the term “enterprise-oriented” refers to a type of profit-making organization that provides services related to automated driving for single AV and/or single traveler. These enterprises not only comprise traditional car manufacturers and tech-companies, but also include providers of automated driving transportation services, suppliers of automated driving technology solutions, component and sensor suppliers, as well as companies offering backend support and cloud services for automated driving. As these enterprises are at the forefront of automated driving, they have access to highly detailed, vast amounts of data related to automated driving. Moreover, these enterprises typically possess robust capabilities in information storage, analysis, and dissemination, supporting the research, testing, and deployment of efficient and safe automated driving systems.

As used herein, the term “users” refers to E-CIU service recipients, including vehicle, road, traveler, auto-company, supplier, and/or tech-company.

As used herein, the term “traveler” refers to individuals who are directly involved in and/or benefit from the movement facilitated by an automated driving system.

As used herein, the term “auto company” refers to companies or business entities involved in the research, design, creation, development, manufacturing, maintenance, and advancement of vehicles and vehicle technologies, with a particular focus on those aspects relevant to automated driving systems.

As used herein, the term “supplier” refers to entities providing the necessary components, and/or materials for building and maintaining automated driving vehicles.

As used herein, the term “tech company” refers to firms specializing in automated driving technological aspects, including software, connectivity, data processing, and cybersecurity.

As used herein, the term “multi-level prediction information” refers to the microscopic-level prediction information, mesoscopic-level prediction information, and/or macroscopic-level prediction information. In some embodiments, the microscopic-level prediction information includes, but not limited to position, speed, acceleration, deceleration, lateral behavior, and longitudinal behavior; the mesoscopic-level prediction information includes, but not limited to spacing, relative speed, time/space headway, safety distance, and collision risk; the macroscopic-level prediction information includes, but not limited to short-term traffic flow, average speed of road sections, and traffic state.

As used herein, the term “demand characteristics” of traffic fence refers to the functional requirements of sensing, prediction, planning and decision making, control, integration and allocation, and service and management put forward by users.

As used herein, the term “supply characteristics” of traffic fence refers to the functional constraints and combined functional schemes that can be provided by subsystems and system components including sensing, prediction, planning and decision-making, control, integration and allocation, service and management.

As used herein, the term “Event” refers to any observable occurrence within a vehicular environment that is recognized by sensors or reported by users. This encompasses a wide range of happenings, from changes in traffic patterns to environmental conditions that could potentially affect vehicular operation or safety. An event may not necessarily lead to an adverse outcome but is indicative of the dynamic nature of the driving ecosystem, warranting monitoring and potential response.

As used herein, the term “Incident” refers to a specific event that disrupts the standard flow of traffic and may pose a risk to vehicle operation, property, or personal safety. Incidents include, but are not limited to, mechanical failures, emergency vehicle deployments, hazardous road conditions, or unauthorized pedestrian presence on the roadway. Incidents carry a greater implication of requiring intervention and may escalate to a “Crash” if not appropriately managed.

As used herein, the term “Crash” refers to an event where a vehicle collides with another vehicle, pedestrian, animal, road debris, or any other stationary obstruction such as a tree or utility pole. It is a type of road traffic incident, that usually involves some degree of injury or property damage. A crash represents the culmination of events and incidents that have led to a significant and often detrimental impact, necessitating immediate and substantial response measures.

As used herein, the term “Near Miss” refers to an event that, under slightly different circumstances, could have resulted in a crash. This includes situations where a collision is narrowly avoided and serves as a warning or indicator of potential risk factors that could lead to an actual crash.

As used herein, the terms “microscopic”, “mesoscopic”, and “macroscopic” refer to relative scales in time and space. In some embodiments, the scales include, but are not limited to, a microscopic level relating to individual vehicles (e.g., longitudinal movements (position, speed, car following, acceleration and deceleration, stopping and standing) and lateral movements (position, steering, lane keeping, lane changing)), a mesoscopic level relating to road corridors and/or segments (e.g., special event early notification, incident prediction, merging and diverging, platoon splitting and integrating, variable speed limit prediction and reaction, segment travel time prediction, and/or segment traffic flow prediction), and a macroscopic level relating to an entire road network (e.g., prediction of potential congestion, prediction of potential incidents, prediction of network traffic demand, prediction of network status, prediction of network travel time). In some embodiments, a time scale at a microscopic level is from less than 10 milliseconds and is relevant to tasks such as vehicle control instruction computation. In some embodiments, a time scale at a mesoscopic level is typically from 10 to 1000 milliseconds and is relevant to tasks such as incident detection and pavement condition notification. In some embodiments, a time scale at a macroscopic level is longer than 1 second and is relevant to tasks such as route computing.

As used herein, the term “automated driving scenario” refers to scenarios specified by E-CIU through traffic fence characteristics, which includes the following levels.

Vehicle-road information interaction: Information communication and interaction can be carried out between vehicles and roads and between vehicles, with a simple sensing function to assist vehicles in realizing decision-making and control functions.

Collaborative sensing, collaborative decision making, and collaborative control functions are not involved. Road has a certain level of intelligence, and the implementation difficulty and system cost are low.

Basic vehicle-road collaboration: Mainly based on collaborative sensing, it has the functions of preliminary collaborative decision-making and collaborative control. Compared with vehicle-road information interaction, it has the basic function of vehicle-road collaboration, so that the implementation difficulty is significantly increased, and the system cost is higher.

Intermediate vehicle-road collaboration: The system defines the primary stage of automated driving, and initially realizes the integration of vehicle, road and cloud. It has the functions of partial collaborative sensing, collaborative decision-making, and collaborative control, and can complete the work of vehicle-road function allocation and local optimization of road sections. Compared with the basic vehicle-road collaboration, roadside intelligent equipment has strong functions, high precision, and high cost, so that the implementation difficulty is slightly increased, and the system cost is increased.

Advanced vehicle-road collaboration: The system defines the intermediate stage of automated driving, and the system has a high degree of collaborative sensing, collaborative decision-making and collaborative control capabilities, and initially realizes the collaborative functions and automated driving functions under all-road, all-weather and all-light conditions. Compared with intermediate vehicle-road collaboration, the implementation difficulty and system cost are greatly reduced by developing streamlined roadside equipment and supporting algorithms.

Vehicle-road collaboration in all scenarios: The system defines the advanced stage of automated driving, and the system reaches the advanced stage of vehicle-road-cloud integration. It has complete functions of cooperative sensing, cooperative decision-making, and cooperative control, realizes cooperative function and automated driving function in all scenarios, and can perform automated driving tasks in all scenarios (including complex automated driving tasks under the road state of mixed traffic of travelers and vehicles). Compared with advanced vehicle-road collaboration, it is necessary to solve the long-tail scenario problem caused by individual extreme conditions, so that the implementation difficulty and system cost are slightly increased.

As used herein, the term “long-tail” scenario, event, environment, etc. refers to a scenario, event, environment, etc. that occurs at a low frequency and/or a scenario, event, environment, etc. that is predicted to occur with a low probability. Exemplary long-tail scenarios, events, and/or environments include, but are not limited to, extreme and/or adverse weather (e.g., snowstorm, icy road, heavy rain, etc.); construction and/or work zones; vehicle accidents; special events (e.g., sports events, hazard evacuation, etc.); hazardous roads (e.g. animals on roads, rough roads, gravel, bumpy edges, uneven expansion joints, slick surfaces, standing water, debris, uphill grade, downhill grade, sharp turns, no guardrails, narrow road, narrow bridge, etc.); unclear road markings, unclear signing, and/or unclear geometric designs; high density of pedestrians and/or bicycles.

As used herein, the term “information services” refers to the extra capability provided by E-CIU to users that users cannot achieve by themselves, including, but not limited to, storage as a service (STaaS), control as a service (CCaaS), computing as a service (CaaS), information as a service (IaaS), sensing as a service (SEaaS), operation and maintenance as a service (OMaaS) and Artificial Intelligence as a service (AIaaS). In some embodiments, STaaS refers to meeting additional storage needs of a single user and/or vehicle, and different subsystems and components of E-CIU. In some embodiments, CCaaS refers to providing additional control capability as a service for a single user and/or vehicle, and different subsystems and components of E-CIU. In some embodiments, CaaS refers to providing entities or groups of entities of a single user and/or vehicle, and different subsystems and components of E-CIU that require additional computing resources. In some embodiments, IaaS refers to providing additional information as a service for a single user and/or vehicle, and different subsystems and components of E-CIU. In some embodiments, SEaaS refers to providing additional sensing capability as a service for single user and/or vehicle, and different subsystems and components of E-CIU. In some embodiments, OMaaS refers to providing additional operation and maintenance capability as a service for a single user and/or vehicle, and different subsystems and components of E-CIU. In some embodiments, AIaaS refers to providing automated driving solutions based on automated driving Artificial Intelligence database as a service for single user and/or vehicle, and different subsystems and components of E-CIU.

As used herein, the term “central cloud” refers to a cloud computing architecture that is a data storage (cloud storage) and computing power center, without direct active management by the user and often has functions distributed over multiple locations; the term “fog cloud” refers to a cloud computing architecture that uses edge devices to carry out a substantial amount of computation (edge computing), storage, and communication locally and routed over the Internet backbone; the term “edge cloud” refers to a cloud computing architecture that brings computation and data storage closer to the sources of data and pushes computation physically closer to a user compared with said fog cloud.

As used herein, the term “service” refers to a process, a function that performs a process, and/or to a component or module that is configured to provide a function that performs a process.

As used herein, the term “information” refers to the information obtained by the system sensors and the information processed by one or more of sensing, prediction, planning and decision making, control, integration and allocation, service and management to complete the automated driving task.

As used herein, the term “engine” refers to the function module of a sensing function, prediction function, decision-making and planning function, control function, execution function, operations function, maintenance function, and/or supporting function.

As used herein, the term “sensing” refers to the function and/or capability of a sensor (e.g., a sensing device provided on a vehicle or road infrastructure) to detect and measure the status of a vehicle and/or the driving environment, e.g., to provide “sensing data”. For example, vehicle sensors detect and measure the status (e.g., location, speed, acceleration, deceleration, and angular movement) of a vehicle and the driving environment (e.g., vehicle surroundings, surrounding and near by objects including vehicles, pedestrians, bicycles, obstacles, road signs and markings, etc.) Vehicle sensors may be provided in different parts of a vehicle.

As used herein, the term “data fusion” refers to integrating a plurality of data sources to provide information (e.g., fused data) that is more consistent, accurate, and useful than any individual data source of the plurality of data sources.

As used herein, the term “data source” refers to any device (e.g., sensors, GPS, etc.) and/or system (e.g., vehicle, road, cloud, network, etc.) that provides data to accomplish the safe operation of automated driving.

As used herein, the term “allocate”, “allocating”, and similar terms refer to resource distribution also include distributing, arranging, providing, managing, assigning, controlling, and/or coordinating resources.

As used herein, the term “resource” refers to computational capacity (e.g., computational power, computational cycles, etc.); memory and/or data storage capacity; sensing capacity; communications capacity (e.g., bandwidth, signal strength, signal fidelity, etc.); and/or electrical power.

As used herein, the term “traveler's personalized travel demand” refers to the traveler's specific requirements for the characteristics of the travel process, including the traveler's preferences for travel path, travel time, travel duration, travel comfort, external environment, and the connection between different modes of transportation.

As used herein, the term “reliability” refers to a measure (e.g., a statistical measure) of the performance of a system without failure and/or error. In some embodiments, reliability is a measure of the length of time and/or number of functional cycles a system performs without a failure and/or error.

As used herein, the term “safety” refers to the state or condition in which the risk of harm or damage is minimized for individuals and property within the vehicular environment. This encompasses the implementation of various technologies, practices, and strategies that collectively enhance the protection of vehicle occupants, pedestrians, and other road users.

As used herein, the term “automated driving Artificial Intelligence database” refers to a large-scale database that contains all types of data needed in the whole process of providing automated driving service. It can be used for AIaaS to learn by combining real-time collected data with big data in the database, and to generate solutions for different automated driving service needs with task orientation. In some embodiments, the database includes, but not limited to:
sensor data: this might include camera footage, radar and LiDAR data, ultrasonic sensor data, etc., capturing the environment around the vehicle;
driving logs: these would document the vehicle's performance across various road conditions, weather, and traffic scenarios;
user interaction data: this includes voice commands, gestures, touchscreen interactions, etc., for training the vehicle to interact with drivers and passengers;
simulated driving data: automated driving systems are frequently tested in virtual environments and data generated from such simulations can be used for training and validation;
annotated data: this is manually labeled data used to indicate the position and type of objects, pedestrians, other vehicles, traffic signs, etc;
control decision data: this would detail decisions made by the automated driving system in various scenarios, like steering, accelerating, decelerating, and braking;
maps and geographic information data: high precision maps and topographical data for navigation and route planning;
traffic rules and regulation data: traffic regulations from various regions, interpretations of speed limits, road signs, etc;
failure and anomaly data: documentation of any system behaviors that deviate from expectations to help improve the system;
real-time feedback data: feedback about system performance from test drivers or real users; language and interaction patterns: for training vehicles on human interaction modalities, possibly involving natural language processing and understanding.

As used herein, the term “full life cycle stages of automated driving” refers to the design phase, manufacturing and testing phase, operation phase, and upgrade phase of automated driving with following definitions:
the design phase refers to the conceptual and system design phase of E-CIU and other automated driving elements, the design of relevant software and/or hardware that meet all lighting, all road networks, all-weather, and all life cycle conditions, with government departments and system integrators as the main body, and cooperate with the automotive, communication, and transportation industries;
the manufacturing and testing phase refers to the manufacturing and test software and/or hardware related to automated driving, including vehicle and onboard equipment, roadside equipment, cloud equipment, and related software, with system integrators and vehicle enterprises as the main body, and cooperation from the automotive industry, communication industry, and transportation industry;
the operation phase refers to deployment and operation of various systems related to automated driving which are completed, with operating companies, vehicle companies, and users as the main body, and cooperation from the transportation industry and government departments;
the upgrade phase refers to local and/or remote upgrades of software and/or hardware related to automated driving, with the operating company and users as the main body, and cooperation from vehicle companies.

As used herein, the term “Full-stack End-to-End Model” refers to integrating the data processing, sensing, fusion, prediction, planning, decision making, and control processes by a foundation model, and mapping the input raw sensor data directly to output as vehicle trajectory or control instructions to achieve vehicle automated driving tasks.

As used herein, the term “Hybrid Sequential Model” refers to separately realizing one or more of the data processing, sensing, fusion, prediction, planning, decision-making, and control processes, and processing the input raw sensor data through the combination of foundation models to output vehicle trajectories or control instructions, to achieve vehicle automated driving tasks.

As used herein, the term “detectable data” refers to the environmental information that the automated driving system's sensors can perceive and recognize, including but not limited to road signs, traffic lights, pedestrians, bikes, animals, vehicles, lane markings, obstacles, traffic lines, road types.

As used herein, the term “undetectable data” refers to the environmental information that cannot be perceived or recognized by the automated driving systems directly, including but not limited to event data (e.g., work zone data, weather data, special event data, traffic control devices data, activity data, incident data, crash data, near miss data, and dangerous driving behavior data, etc.)

As used herein, the term “request response mode” refers to an AV sending a remote driving request to the service and management subsystem of the E-CIU, which processes the request and sends back a response.

As used herein, the term “forced-provision mode” refers to a remote driving scenario and service provisioning where resources or services of the E-CIU are allocated or provisioned regardless of demand.

As used herein, the term “eight functions” refers to enhancement, complement, backup, elevation, replacement, monitoring, operation, and maintenance functions configured to support automated driving-related tasks for users:

“enhancement” refers to the corresponding enhancement of functions including sensing, prediction, decision and planning, control, operation and maintenance, management, and service when they cannot meet the requirements of the AV;
“complement” refers to the complement of missing functions in sensing, prediction, planning and decision making, control, operation and maintenance, management, service of the AV;
“backup” refers to providing data redundancy backup and functional redundancy backup through supporting subsystems to improve robustness of the AV operations;
“elevation” refers to the improvement of the intelligence level of the AV, which is achieved through the integration and allocation subsystem and supporting subsystem;
“replacement” refers to the replacement of function or equipment related to AV's sensing, prediction, planning and decision making, control, operation and maintenance, management, service and other functions when they fail or related equipment fails;
“monitoring” refers to, on the premise of complying with the privacy protection principle, including but not limited to driver status monitoring, environmental status monitoring, vehicle status monitoring and automated driving system monitoring;
“operation” refers to device operation and functional operation of the AV; and
“maintenance” refers to equipment maintenance and functional maintenance of the AV.

As used herein, the term “automation and/or intelligence levels of CAVs” refers to one of the following “intelligence level” and/or an “automation level”: V0: No automation functions; V1: Basic functions to assist a human driver to control a vehicle; V2: Functions to assist a human driver to control a vehicle for simple tasks and to provide basic sensing functions; V3: Functions to sense the environment in detail and in real-time and to complete relatively complicated driving tasks; V4: Functions to allow vehicles to drive independently under limited conditions and sometimes with human driver backup; and V5: Functions to allow vehicles to drive independently without human driver backup under all conditions. As used herein, a vehicle having an intelligence level of 1.5 (V1.5) refers to a vehicle having capabilities between vehicle intelligence 1 and vehicle intelligence level 2, e.g., a vehicle at V1.5 has minimal or no automated driving capability but comprises capabilities and/or functions (e.g., hardware and/or software) that provide control of the V1.5 vehicle by a CADS system (e.g., the vehicle has “enhanced driver assistance” or “driver assistance plus” capability).

### DESCRIPTION

### Enterprise-oriented Cloud Intelligent Unit (E-CIU)

The present technology provides an Enterprise-oriented Cloud Intelligent Unit (E-CIU) and related methods (e.g., serving methods) configured to provide a CAV and/or AV with automated driving services (e.g., automated driving travel service). Although the disclosure herein refers to certain illustrated embodiments, it is to be understood that these embodiments are presented by way of example and not by way of limitation.

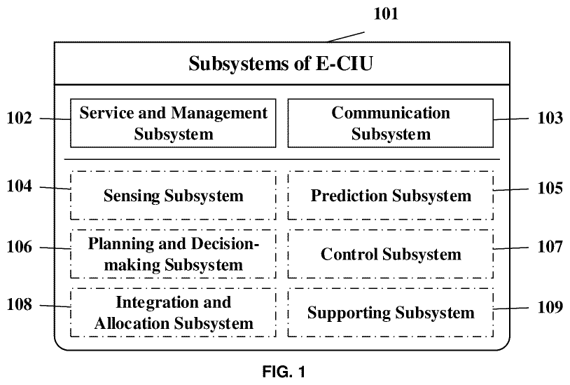

In some embodiments, e.g., as shown in FIG. 1, the E-CIU 101 comprises a service and management subsystem 102 and a communication subsystem 103, and one or more of: a sensing subsystem 104, a prediction subsystem 105, a planning and decision-making subsystem 106, a control subsystem 107, an integration and allocation subsystem 108, and a supporting subsystem 109.

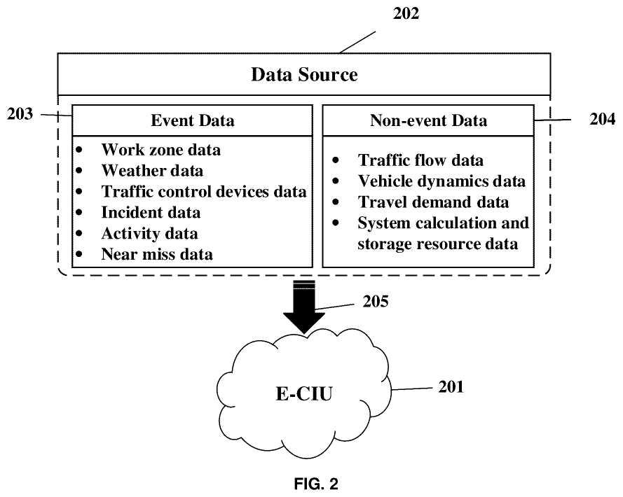

In some embodiments, e.g., as shown in FIG. 2, the data source 202 of E-CIU 201 comprises event data 203 and non-event data 204. Event data 203 includes one or more of work zone data, weather data, traffic control devices data, incident data, activity data, and near miss data. Non-event data 204 includes one or more of traffic flow data, vehicle dynamics data, travel demand data, and system calculation and storage resource data. The data from data source 202 can be sent to E-CIU 201 through communication 205.

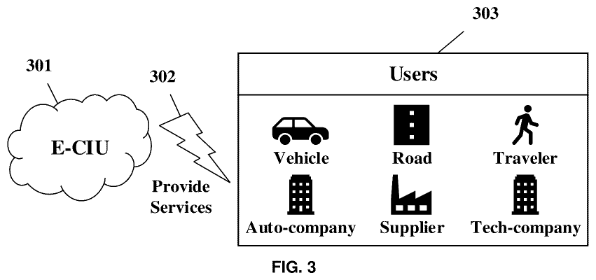

In some embodiments, e.g., as shown in FIG. 3, the E-CIU 301 provides services 302 to users 303. In some embodiments, users 303 include vehicle, road, traveler, auto-company, supplier, and tech-company.

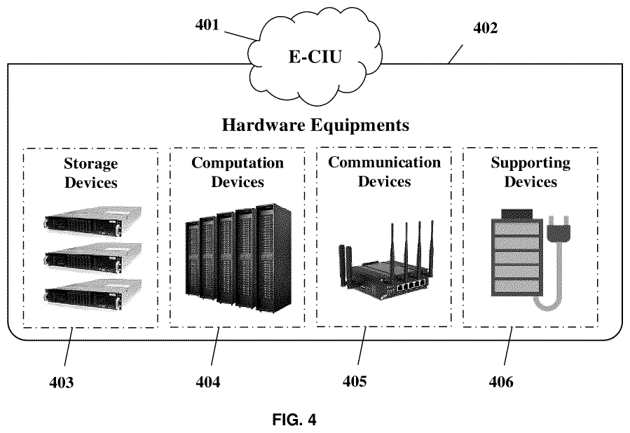

In some embodiments, e.g., as shown in FIG. 4, the hardware equipment 402 of E-CIU 401 comprises storage devices 403, computing devices 404, communication devices 405, and supporting devices 406. In some embodiments, the storage device 403 includes local storage facilities and cloud storage facilities. In some embodiments, the computing device 404 includes one or more of CPU, GPU, RAM, and ROM. In some embodiments, the communication device 405 includes wireless communication facilities and wired communication facilities. In some embodiments, the supporting device 406 includes power supply facilities.

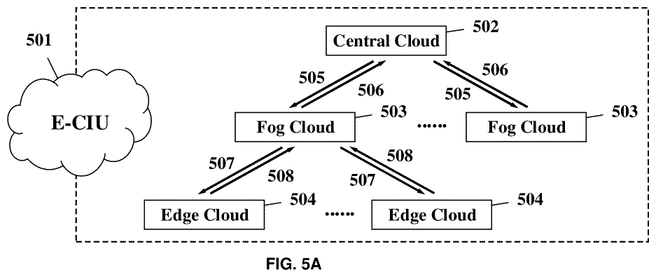

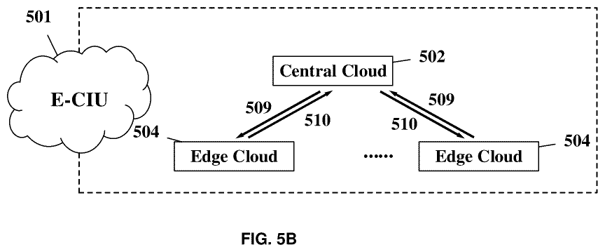

In some embodiments, e.g., as shown in FIG. 5A, The composition of E-CIU 501 in the cloud includes the central cloud 502, fog cloud 503, and edge cloud 504. The data information is transmitted from the central cloud 502 to the fog cloud 503 via communication 505. The data information is transmitted from fog cloud 503 to the central cloud 502 via communication 506. The data information is transmitted from fog cloud 503 to the edge cloud 504 via communication 507. The data information is transmitted from the edge cloud 504 to the fog cloud 503 via communication 508.

In some embodiments, e.g., as shown in FIG. 5B, the data information is transmitted from the central cloud 502 to the edge cloud 504 via communication 509 directly. In some embodiments, the data information is transmitted from the edge cloud 504 to the central cloud 502 via communication 510 directly.

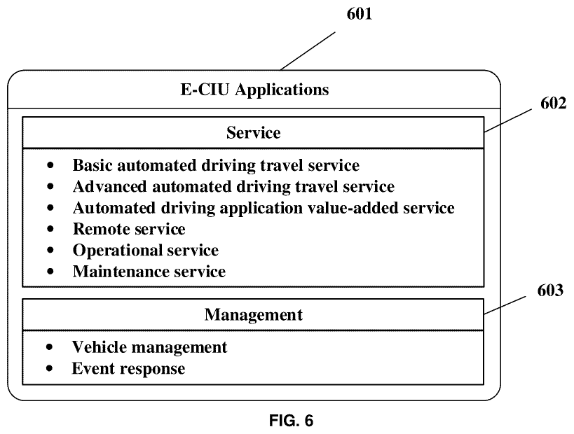

In some embodiments, e.g., as shown in FIG. 6, the E-CIU applications 601 comprises service 602 and management 603. In some embodiments, the service 602 comprises basic automated driving travel service, advanced automated driving travel service, automated driving application value-added service, remote services, operational service, and/or maintenance service. In some embodiments, the management 603 comprises vehicle management or event response.

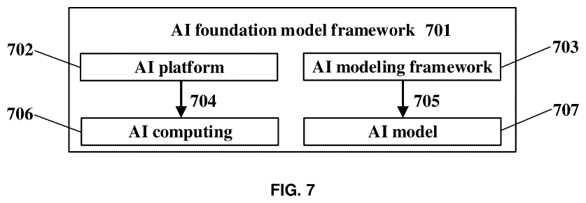

In some embodiments, e.g., as shown in FIG. 7, the technology provides an AI foundation framework 701. The AI foundation model framework 701 comprises AI platform 702 and/or AI modeling framework 703. The AI platform 702 is configured to provide 704 AI computing 706. The AI modeling framework 703 is configured to provide 705 AI model 707.

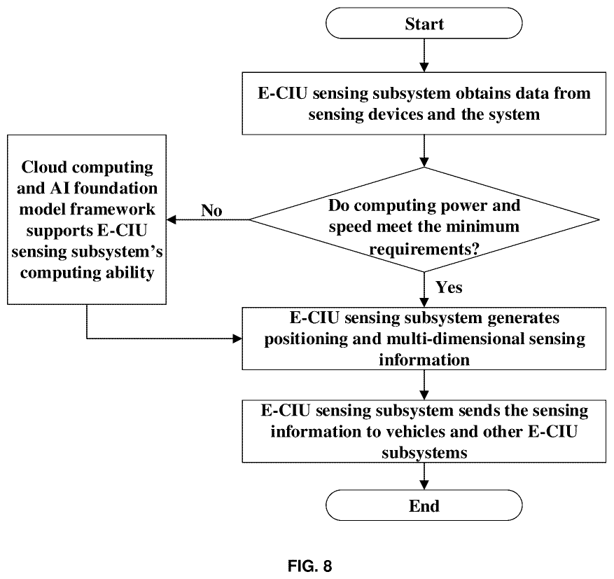

In some embodiments, e.g., as shown in FIG. 8, the technology provides an operation method of the sensing subsystem. The sensing subsystem obtains data of sensing devices and the system, and processes the positioning and multi dimensional sensing information. If the computing power and speed of the sensing subsystem do not meet the minimum requirements, the cloud computing and AI foundation model framework will provide the computing ability support. The E-CIU sensing subsystem sends the sensing information to vehicles and other E-CIU subsystems. In some embodiments, the other E-CIU subsystems include one or more of service and management subsystem, communication subsystem, prediction subsystem, planning and decision making subsystem, control subsystem, integration and allocation subsystem, and a supporting subsystem.

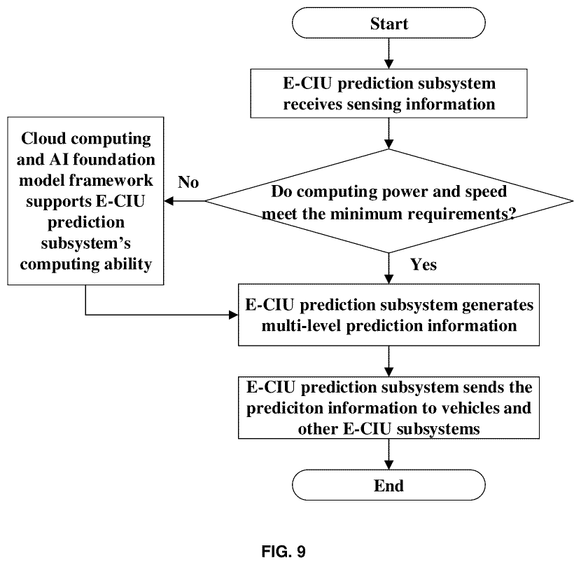

In some embodiments, e.g., as shown in FIG. 9, the technology provides an operation method of the prediction subsystem. The prediction subsystem receives the sensing information and generates multi-level prediction information. If the computing power and speed of the prediction subsystem do not meet the minimum requirements, the cloud computing and AI foundation model framework will provide computing ability support. The E-CIU prediction subsystem sends the prediction information to vehicles and other E-CIU subsystems.

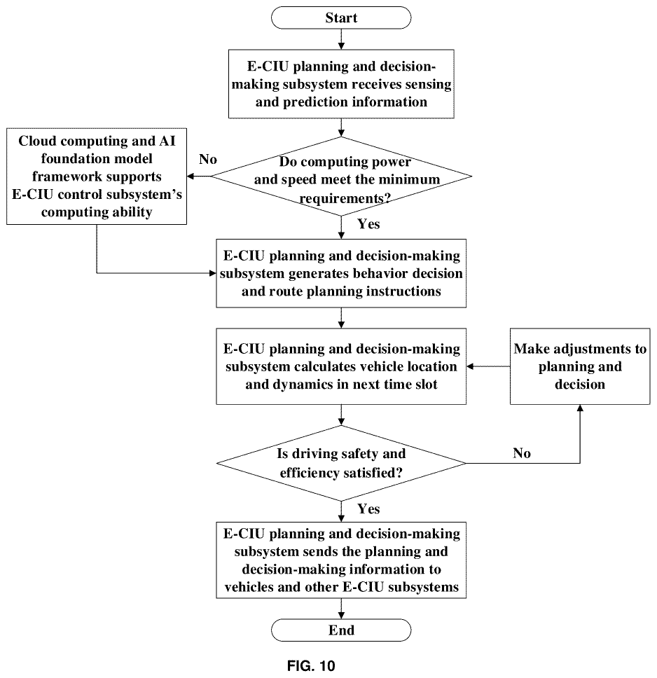

In some embodiments, e.g., as shown in FIG. 10, the technology provides an operation method of the planning and decision making subsystem. The planning and decision-making subsystem receives the sensing and prediction information, generates behavior decision and route planning instructions, and calculates the vehicle position and dynamics parameters in the next time slot. The E-CIU planning and decision-making subsystem sends planning and decision making information to vehicles and other E-CIU subsystems. If the computing power and speed of the prediction subsystem do not meet the minimum requirements, the cloud computing and AI foundation model framework will provide computing ability support. If the safety and efficiency thresholds (e.g., speed, headway, etc.) do not meet the requirements, the planning and decision making subsystem makes adjustments to the planning and decision.

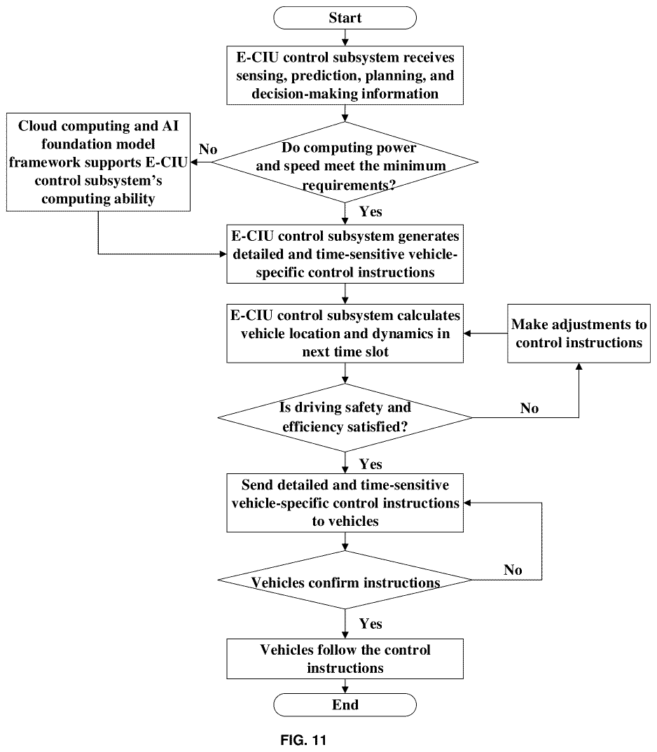

In some embodiments, e.g., as shown in FIG. 11, the technology provides an operation method of the control subsystem. The control subsystem receives the information of sensing, prediction, planning and decision-making, generates detailed and time-sensitive vehicle-specific control instructions, and calculates the vehicle position and dynamics parameters in the next time slot. If the computing power and speed of the control subsystem do not meet the minimum requirements, the cloud computing and AI foundation model framework will provide computing ability support. If the safety and efficiency thresholds (e.g., speed, headway, etc.) meet the requirements, the control instructions are sent to the vehicles. The vehicles follow the control instructions to drive. If the control instructions are not confirmed, new instructions are sent to the vehicles.

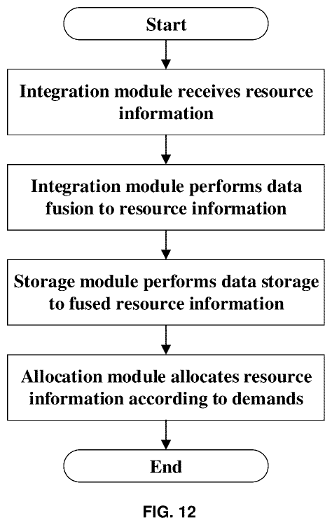

In some embodiments, e.g., as shown in FIG. 12, the technology provides an operation method of the integration module and the allocation module. The integration module receives resource information of vehicles, roads, TCC/TCUs and E-CIU from the communication subsystem and the interface module, and said resource information includes function, data, and computing power of subsystems and/or components. The integration module then performs data fusion for different types of resource information received, and the fused resource information is stored by the storage module. The allocation module allocates and sends the resource information to different subsystems and/or components according to demands.

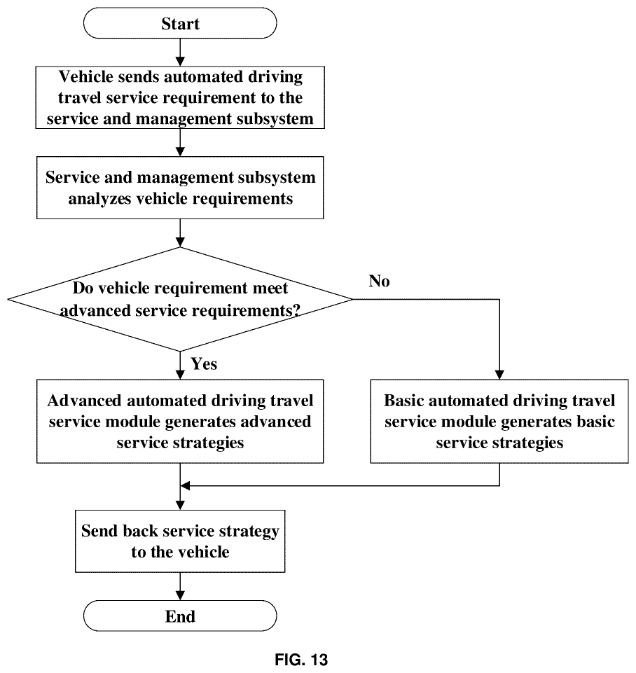

In some embodiments, e.g., as shown in FIG. 13, the technology provides an operation method of basic and advanced automated driving travel service modules. The vehicle sends automated driving travel service requirement to the service and management subsystem of the E-CIU. The service and management subsystem analyzes vehicle requirement and judges if the requirement meets advanced service requirements. If it does, the advanced automated driving travel service module generates advanced service strategies. If not, the basic automated driving travel service module generates basic service strategies. Then, the service strategies are sent back to the vehicle.

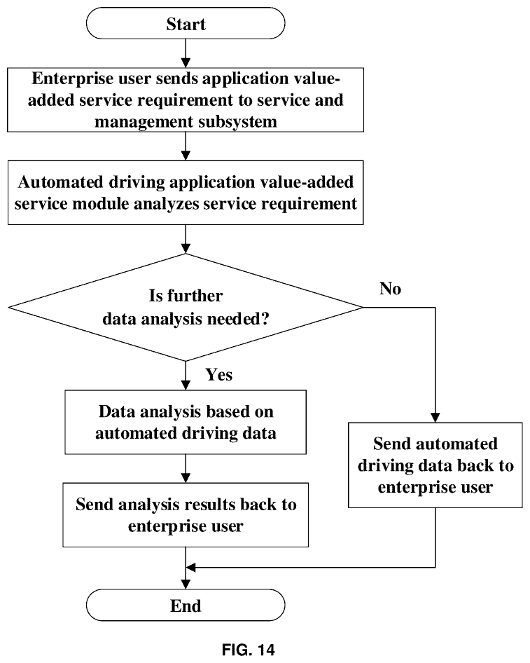

In some embodiments, e.g., as shown in FIG. 14, the technology provides an operation method of automated driving application value-added service module. The enterprise user sends application value-added service requirement to the service and management subsystem. The automated driving application value-added service module analyzes service requirement. If further data analysis is needed, the automated driving application value-added service module performs data analysis based on automated driving data and sends results back to the enterprise user. If not, the automated driving application value-added service module sends the automated driving data back to enterprise user.

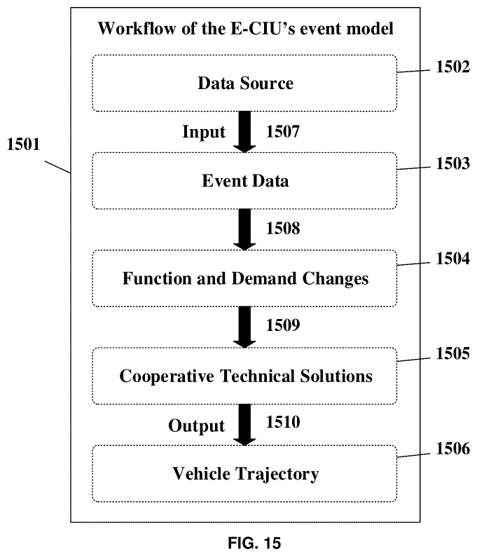

In some embodiments, e.g., as shown in FIG. 15, the technology provides the workflow of an Event Model 1501. The event model receives sensing information of data source 1502 including vehicles, roads and the historical and/or real-time monitoring data of the traffic management center and meteorological department through the communication subsystem and extracts event data as the input 1507. The event data 1503 comprises work zone data, weather data, traffic control data, incident data, event data, and near miss data. These event data are analyzed for their impact on function and demand 1504 including sensing, prediction, planning and decision-making, and control through data-driven machine learning methods 1508. The event model obtains the function, resource, and state information of users and subsystems and/or components of the E-CIU, and generates cooperative technical solutions 1505 based on cloud computing, including cooperative sensing, cooperative prediction, cooperative planning and decision making, and cooperative control technologies 1509. Based on the cooperative technical solutions, the event model generates vehicle trajectory 1506 through the cloud computing module and AIaaS 1510.

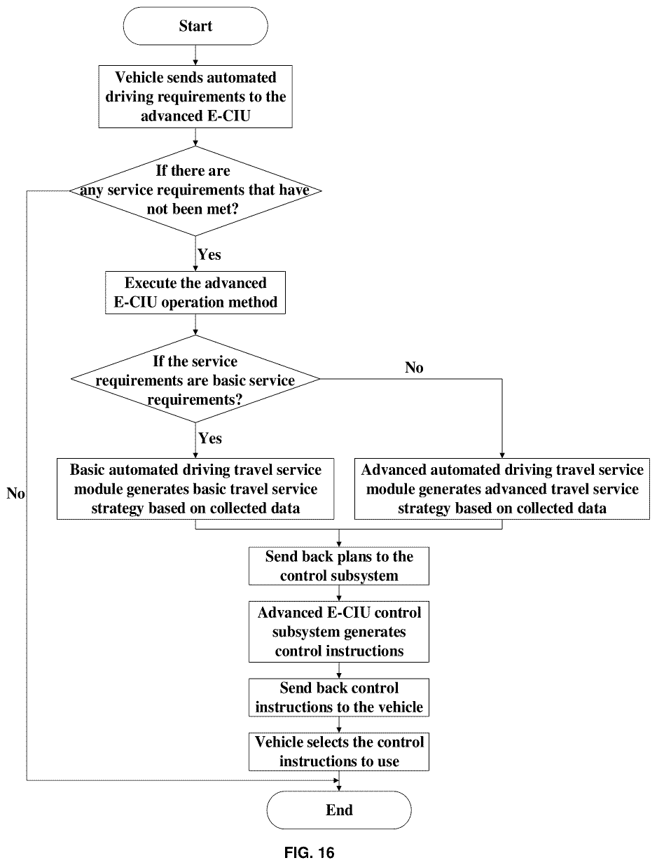

In some embodiments, e.g., as shown in FIG. 16, the technology provides an operation method of the advanced E-CIU. First, the vehicle sends automated driving requirements to the advanced E-CIU. The advanced E-CIU determines if there are any service requirements that have not been met. If yes, the advanced E-CIU executes the advanced E-CIU operation method. This method determines whether the service requirements are basic service requirements. If they are basic service requirements, a basic automated driving travel service module generates a basic travel service strategy based on collected data, and the strategy is returned to the control subsystem. If not, an advanced automated driving travel service module generates an advanced travel service strategy based on the data collected, and the strategy is returned to the control subsystem. Finally, the control subsystem generates control instructions according to service strategies and sends them to the vehicle. The vehicle is controlled by selecting the control instructions.

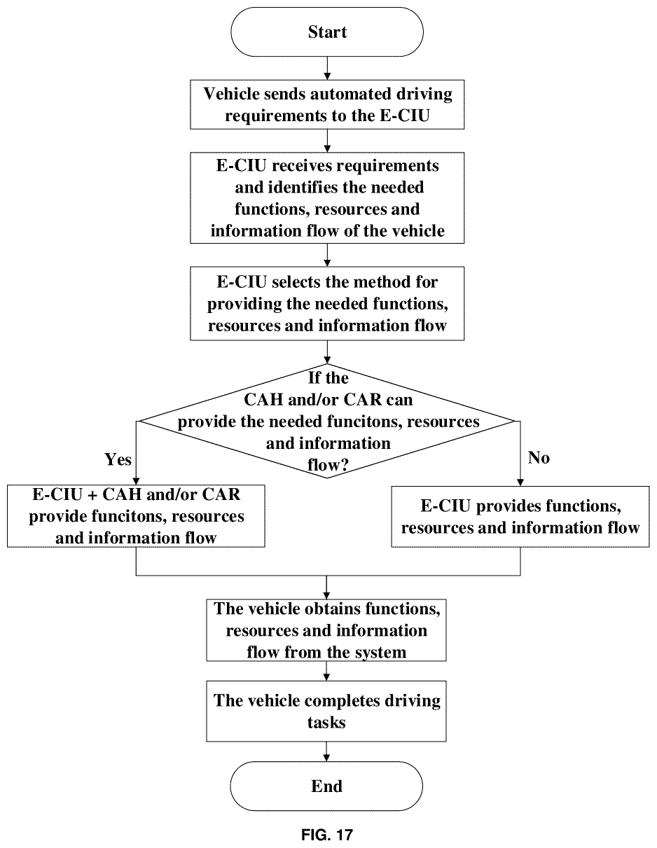

In some embodiments, e.g., as shown in FIG. 17, the technology provides a cooperative operation method. First, the vehicle sends automated driving requirements to the E-CIU. Then, the E-CIU receives requirements and identifies the needed functions, resources, and information flow of the vehicle. The E-CIU selects the method for providing the needed functions, resources, and information flow (e.g., sensing, prediction, planning, and/or control) if the CAH and/or CAR can provide the needed functions, resources, and information flow. Then, the E-CIU, CAH and/or CAR provide functions, resources, and information flow. If not, the E-CIU provide functions, resources, and information flow. The vehicle obtains functions, resources, and information flow from the system to complete driving tasks.

The following tables describe embodiments of the E-CIU and its subsystem and components described herein. Table 1 provides a summary of the E-CIU and its subsystems and components. As shown in Table 1, the E-CIU components or subsystems comprise: (1) service and management subsystem; (2) communication subsystem; and one or more of (3) sensing subsystem; (4) prediction subsystem; (5) planning and decision-making subsystem; (6) control subsystem; (7) integration and allocation subsystem; (8) supporting subsystem. Further, the technology described herein provides embodiments of various types of E-CIU and their combinations of subsystems, comprising, e.g., (1) Sensing-centric E-CIU; (2) Position-centric E-CIU; (3) Prediction-centric E-CIU; (4) Planning and decision-making-centric E-CIU; (5) Control-centric E-CIU; (6) Integration and allocation-centric E-CIU; (7) Advanced E-CIU.

TABLE 1
Summary of E-CIU and Subsystems

| | E-CIU Subsystem | | | | | | | |
|---|---|---|---|---|---|---|---|---|
| | | | | | Planning | | | |
| | Service | | | | and | | Integration | |
| E-CIU | and | Communi- | | | decision- | | and | |
| Type | management | cation | Sensing | Prediction | making | Control | allocation | Supporting |
| Sensing- | ✓ | ✓ | ✓ | | | | | |
| centric | | | | | | | | |
| E-CIU | | | | | | | | |
| Position- | ✓ | ✓ | ✓ | | | | | ✓ |
| centric | | | | | | | | |
| E-CIU | | | | | | | | |
| Prediction- | ✓ | ✓ | | ✓ | | | | |
| centric | | | | | | | | |
| E-CIU | | | | | | | | |
| Planning | ✓ | ✓ | | | ✓ | | | |
| and | | | | | | | | |
| decision- | | | | | | | | |
| making- | | | | | | | | |
| centric | | | | | | | | |
| E-CIU | | | | | | | | |
| Control- | ✓ | ✓ | | | | ✓ | | |
| centric | | | | | | | | |
| E-CIU | | | | | | | | |
| Integration | ✓ | ✓ | | | | | ✓ | |
| and | | | | | | | | |
| allocation- | | | | | | | | |
| centric | | | | | | | | |
| E-CIU | | | | | | | | |
| Advanced | ✓ | ✓ | ✓ | ✓ | ✓ | ✓ | ✓ | ✓ |
| E-CIU | | | | | | | | |

In some embodiments, the sensing-centric E-CIU comprises: (1) service and management subsystem; (2) communication subsystem; and (3) sensing subsystem. In some embodiments, the position-centric E-CIU comprises: (1) service and management subsystem; (2) communication subsystem; (3) sensing subsystem; and (4) supporting subsystem. In some embodiments, the prediction-centric E-CIU comprises: (1) service and management subsystem; (2) communication subsystem; and (3) prediction subsystem.

In some embodiments, the planning and decision-making-centric E-CIU comprises: (1) service and management subsystem; (2) communication subsystem; and (3) planning and decision making subsystem. In some embodiments, the control-centric E-CIU comprises: (1) service and management subsystem; (2) communication subsystem; and (3) control subsystem.

In some embodiments, the integration and allocation-centric E-CIU comprises: (1) service and management subsystem; (2) communication subsystem; and (3) integration and allocation subsystem.

In some embodiments, the advanced E-CIU comprises: (1) service and management subsystem; (2) communication subsystem; (3) sensing subsystem; (4) prediction subsystem; (5) planning and decision making subsystem; (6) control subsystem; (7) integration and allocation subsystem; and (8) supporting subsystem.

In some embodiments, a traffic fence is configured to classify automated driving scenarios according to the traffic fence function below:

$$F = {\sum }_{i}^{m} {α}_{i} {x}_{i} + {\sum }_{i}^{n} {β}_{i} {y}_{i} + {\sum }_{i}^{l} {γ}_{{i}^{Z} i}$$

wherein:
xᵢ is the quantitative assignment of each factor on the supply side of traffic fence,
yᵢ is the quantitative assignment of each factor on the demand side of traffic fence,
zᵢ is the quantitative assignment of each element of application scenario,
αᵢ is the weight coefficient of each factor on the supply side of traffic fence,
βᵢ is the weight coefficient of each factor on the demand side of traffic fence,
γᵢ is the weight coefficient of each element of application scenario,
m is the total number of traffic fence supply-side factors,
n is the total number of traffic fence demand-side factors,
l is the total number of application scenario factors,
F is the function value of traffic fence, and
the weight coefficient αᵢ, βᵢ, and γᵢ satisfy the following requirements:

$${\sum }_{i}^{n} {α}_{i} + {\sum }_{i}^{n} {β}_{i} + {\sum }_{i}^{n} {γ}_{i} = 1.$$

In some embodiments, the traffic demand characteristic is the automated driving request generated by the demand side of automated driving service, such as function requirement, intelligence requirement, and equipment requirement and the traffic supply characteristic refers to the computing, storage, and other functions and resources that the E-CIU subsystems and components can provide.

In some embodiments, as shown in Table 2, the value range of the traffic fence function dictates the level of the traffic fence. The pre-defined values of the traffic fence function include: F₁, F₂, F₃, F₄, F₅.

TABLE 2
Levels and Function Values of Traffic Fence

| Level of the | | | | | |
|---|---|---|---|---|---|
| traffic fence | 1 | 2 | 3 | 4 | 5 |
| Value range of the | F₁ | (F₁, F₂] | (F₂, F₃] | (F₃, F₄] | (F₄, F₅] |
| traffic fence function | | | | | |

In some embodiments, based on the classification of traffic fence levels, automated driving scenarios can also be classified as five levels as follows:

Vehicle-road information interaction. The information communication and interaction can be achieved between vehicles and roads and among vehicles, with a simple sensing function to assist vehicles in realizing decision-making and control functions. Collaborative sensing, collaborative decision-making, and collaborative control functions are not involved. Road has a certain level of intelligence, and the implementation difficulty and system cost are low.

Basic vehicle-road collaboration. Based on collaborative sensing, it has the functions of preliminary collaborative decision making and collaborative control. Compared with vehicle-road information interaction, it has the basic function of vehicle-road collaboration, and thus the implementation difficulty is significantly increased and the system cost is higher.

Primary vehicle-road-cloud collaboration. The system defines the primary stage of automated driving and initially realizes the integration of vehicle, road, and cloud. It has the functions of partial collaborative sensing, collaborative decision-making, and collaborative control, and can complete the vehicle-road-cloud function allocation and local traffic optimization of road sections. Compared with the basic vehicle-road collaboration, roadside intelligent equipment has strong functions, high precision, and high cost, and thus the implementation difficulty is slightly increased, and the system cost is increased.

Advanced vehicle-road-cloud collaboration. The system defines the intermediate stage of automated driving. The system has a high degree of collaborative sensing, collaborative planning and decision-making, and collaborative control capabilities, and initially realizes the collaborative functions and automated driving functions under all-road, all-weather, and all-light conditions. Compared with primary vehicle-road-cloud collaboration, the implementation difficulty and system cost are greatly reduced by developing streamlined roadside equipment and supporting algorithms.

Vehicle-road-cloud collaboration in all scenarios. The system defines the advanced stage of automated driving, and the system reaches the advanced stage of vehicle-road-cloud integration. It has complete functions of collaborative sensing, collaborative planning and decision-making, and collaborative control, realizes collaborative functions and automated driving functions in all scenarios, and can perform automated driving tasks in all scenarios (including complex automated driving tasks under the road state of mixed traffic of vehicles and travelers). Compared with advanced vehicle-road-cloud collaboration, it is necessary to solve the long-tail scenario problems caused by individual extreme conditions, and thus the implementation difficulty and system cost are slightly increased.

In some embodiments, the E-CIU provides automated driving services at the microscopic level, mesoscopic level, and/or macroscopic level. The spatiotemporal granularity for each level is defined below:
Spatial dimension:
Microscopic level: 0.1 cm˜1 cm or less
Mesoscopic level: 1 cm˜100 cm
Macroscopic level: greater than 100 cm;
Temporal dimension:
Microscopic level: 1 ms˜10 ms or less
Mesoscopic level: 10 ms˜1000 ms
Macroscopic level: greater than 1000 ms.

In some embodiments, the E-CIU provides one or more automated driving services to different users. Said automated driving service comprises basic automated driving travel service, advanced automated driving travel service, automated driving application value-added service, remote service, operational service, and maintenance service.

In some embodiments, the E-CIU's sensing subsystem can provide positioning and multi-dimensional sensing functions, using specific methods such as local and global sensing, heterogeneous sensing, and network sensing methods. These methods are noted below.

The positioning function provides microscopic-level positioning of AVs or CAVs through the communication subsystem and cloud computing module, and the positioning information serves as the functional basis of each subsystem and supports remote services of E-CIU.

The local and global sensing method integrates local sensing data; wherein said local sensing data represents vehicle operation and the global sensing data represents CAVH and transportation network states and events.

The heterogeneous sensing method receives data with resolution, type, coverage, and frequency information from sensors, wherein the sensors include but is not limited to computer vision, radar, and LiDAR.

The network sensing method can communicate with external data sources for emergency management and integrated management of multiple transportation modes.

In some embodiments, the prediction subsystem of the E-CIU can provide multi-level prediction functions for CAVs and/or AVs including but not limited to vehicle behavior prediction methods, vehicle collision prediction methods, and traffic state prediction methods. These methods are noted below.

The behavior prediction method predicts microscopic-level CAV behavior, including but not limited to speed, acceleration, lateral behavior, and longitudinal behavior.

The collision prediction method predicts mesoscopic-level relationships among CAVs, including but not limited to relative speed, time/space headway, safety distance, and collision risk.

The traffic state prediction method predicts macroscopic-level traffic flow state, including but not limited to short-term traffic flow, average speed of road sections, and traffic state.

In some embodiments, the planning and decision-making subsystem of the E-CIU can provide decision and planning functions, including but not limited to CAV s and/or AVs behavior decision-making method and CAV route planning method. These methods are noted below.

The behavior decision-making method provides behavior decision-making instructions or recommendations to CAVs, including but not limited to car-following, lane changing, gap acceptance, acceleration/deceleration, and emergency stop.

The route planning method provides one or more optimal routes, including but not limited to the least travel time route, the least cost route, the least traffic lights route, and the no accident route.

In some embodiments, the control subsystem of the E-CIU is configured to provide vehicle control functions, including single-vehicle control method, platoon control method, and cooperative control method. These methods are noted below.

The single-vehicle control method provides control instructions to a single CAV and/or AV, including one or more of longitudinal and lateral position, speed, acceleration/deceleration, steering, and stopping.

The platoon control method provides control instructions to all CAVs and/or AVs in the platoon and each CAV and/or AV in the platoon, including one or more of platoon cruise control, single CAV and/or AV control of entry or exit from the platoon, and platoon formation or dissolution.

The collaborative control method provides collaborative control instructions to multiple CAVs and/or AVs, including one or more of signal-free intersection passing, collaborative merging and exiting in a weaving zone, collaborative lane-changing, and regional collaborative control.

In some embodiments, the E-CIU is configured to provide real-time vehicle control and data processing. In some embodiments, the real-time vehicle control and data processing are automated based on preinstalled algorithms.

In some embodiments, the communication subsystem of E-CIU is configured to realize the establishment and data transceiver of communication channels among subsystems, components, and users of the E-CIU through communication modes. These communication subsystems and models are noted below.

The communication subsystem is configured to communicate among one or more subsystems and users, wherein said subsystems include the sensing subsystem, prediction subsystem, planning and decision-making subsystem, control subsystem, service and management subsystem, integration and allocation subsystem, and supporting subsystem; said users include vehicle, road, traveler, auto-company, supplier and tech-company.

The communication modes of said communication subsystem include one or more of dedicated short range communication (DSRC), cellular network, 4G/5G/6G/7G, Bluetooth, C-V2X, Starlink, and other wired or wireless communication methods.

The communication subsystem is capable of providing microscopic-level (characterized by high accuracy and low latency) communication and network service.

In some embodiments, the integration and allocation subsystem acquires function and resource information of each subsystem through the communication subsystem, integrates and allocates function and resources of each subsystem. The workflow of said integration and allocation subsystem is as follows.

The integration and allocation subsystem exchanges information within and/or outside the system through the communication subsystem.

The integration and allocation subsystem analyzes CAVs' and/or AVs' functional demand at different spatial-temporal levels and integrates and allocates the demand of functions and/or resources.

The integration and allocation subsystem combines functions and/or resources of sensing, prediction, planning and decision-making, control, and cloud computing to meet functional demand at different spatial-temporal levels.

In some embodiments, the edge computing of the cloud computing module allows real-time processing and analysis of data near the data source, and the data does not need to be directly uploaded to the cloud or centralized data processing system. The edge computing provides one or more of the following functions:

combining with artificial intelligence technology to provide better intelligent functions, including data analysis and sensing under multiple scenarios;
providing microscopic-level computing and decision-making support for one or more of the subsystems and/or components of the E-CIU to enhance the computing efficiency and power of the E-CIU;
combining with the central cloud computing and/or fog cloud computing of the cloud computing module, realizing the mesoscopic and/or macroscopic computing support, and reducing the use cost.

In some embodiments, the E-CIU is configured to provide information service for users according to the requirements, and said service comprises storage as a service (STaaS), control as a service (CCaaS), computing as a service (CaaS), information as a service (IaaS), sensing as a service (SEaaS), operation and maintenance as a service (OMaaS) and Artificial Intelligence as a service (AIaaS).

In some embodiments, the information service module is configured to provide users with information service, comprising one or more of:
Storage as a service (STaaS), meeting additional storage needs of users; Control as a service (CCaaS), providing additional control capability as a service for users;
Computing as a service (CaaS), providing entities or groups of entities of users that require additional computing resources;
Information as a service (IaaS), providing additional information capability as a service for users;
Sensing as a service (SEaaS), providing additional sensing capability as a service for users;
Operation and maintenance as a service (OMaaS), providing additional operation and maintenance capability as a service for users; and
Artificial Intelligence as a service (AIaaS), providing additional capability of automated driving models, data and computing power as a service for users.

In some embodiments, the AIaaS is configured to provide a combined solution of subsystems and/or components of the E-CIU to meet specific demand of automated driving service, based on the automated driving Artificial Intelligence database and cloud computing module.

In some embodiments, the automated driving Artificial Intelligence database refers to a large-scale database that contains all types of data needed in the entire process of providing automated driving service. It can be used for AIaaS to learn by combining real-time data with historical big data in the database, and to generate solutions for satisfying the requirements of different automated driving service needs with task orientation.

In some embodiments, the AIaaS is configured to utilize the Artificial Intelligence database as an input to the AI model framework and based on the computing support provided by the AI computing platform. In some embodiments, the AI modeling framework is configured to provide unified training and control instructions for the vehicle.

In some embodiments, the unified training comprises performing integrated training on the sensing subsystem, the prediction subsystem, the planning and decision-making subsystem, and the control subsystem. In some embodiments, the unified training is configured to directly learn from the sensor data to generate the final driving decisions and control instructions to accomplish the automated driving task.

In some embodiments, the E-CIU provides one or more automated driving services to different users; and said automated driving service comprises basic automated driving travel service, advanced automated driving travel service, automated driving application value-added service, remote service, operational service, and maintenance service.

In some embodiments, the remote driving service comprises remote driving services in emergency and non-emergency scenarios, which are described below.:
the emergency scenarios refer to adverse weather conditions, sudden obstacles, unexpected traffic conditions, and other external emergencies when the driver lacks the ability to ensure safety through manual operation;
the non-emergency situations refer to scenarios when the driver has the capability to operate safely under the premise of safety assurance, or when CAV or AV is capable of ensuring safe operation.

In some embodiments, the remote driving service is configured to process and analyze the data collected and execute computing tasks through the cloud computing module and one or more of the AIaaS and the event model.

In some embodiments, the remote driving service is provided by request-response mode or forced provision mode according to the urgency of the scenarios below:
in emergency scenarios, the remote driving service is compulsorily provided by the E-CIU to ensure safety of CAVs or AVs and the travelers;
in non-emergency scenarios, the remote driving service is provided by the E-CIU according to the users' request.

In some embodiments, the remote rescue service comprises software fault repair, allocation of rescuers, and supply of rescue equipment, which are described below.

Software fault remediation: Software fault remediation addresses software-related issues in the automated driving system. Software fault is diagnosed via the E-CIU and corrected through deploying and/or updating patches.

Rescue personnel allocation: If on-site intervention becomes essential due to hardware or other complications, the allocation of rescue personnel is vital. The type and location of the problem determine the selection of technicians. Efficient coordination of their schedules guarantees their timely presence at the required location.

Rescue equipment provision: Rescue equipment provision involves identifying the required items, checking local inventories or nearby supply points, and ensuring their swift and safe delivery to the site.

In some embodiments, the operational methods of the basic automated driving travel service module and the advanced automated driving travel service module are described as follows.

CAVs or AVs send requests to the E-CIU, and the request is received and sent to the service and management subsystem by the communication subsystem.

The operational methods execute the advanced automated driving travel service module and judge whether the request is basic or advanced.

The basic or advanced automated driving travel service module generates the service strategies.

The communication subsystem sends the service strategy to the control subsystem. The control subsystem generates control instruction and sends it to CAVs or AVs.

CAVs or AVs execute the control instructions and send back information to the advanced automated driving travel service module for further optimization until the service request is met.

In some embodiments, the application value-added service module is configured to provide data analytics services to the enterprise. In some embodiments, the data analytics services include a vehicle full life cycle quality analysis. In some embodiments, the data analytics services include analyzing the driving conditions of the group of vehicles. In some embodiments, the data analytics services include analyzing the demand for vehicle sales and after-sale service.

In some embodiments, the enterprise includes an auto-company, supplier, and/or tech company.

In some embodiments, for CAVs or AVs, a vehicle operation management module is configured to provide microscopic-level and mesoscopic-level information fusion and storage. In some embodiments, for CAVs or AVs, a vehicle management module is configured to provide microscopic-level and mesoscopic-level prediction for behavior, traffic flow, and/or traffic state.

In some embodiments, for CAVs or AVs, a vehicle operation management module is configured to provide planning and decision making plans. In some embodiments, for CAVs or AVs, a vehicle operation management module is configured to provide optimal control instructions.

In some embodiments, the operation logic of the event model is as follows.

The event model receives sensing information of vehicles and roads and the historical and/or real-time monitoring data of the traffic management center and meteorological department through the communication subsystem, and extracts event data as the input.

The event model analyzes the function and demand changes brought by event data to sensing, prediction, planning and decision-making, and control.

The event model obtains the function, resource, and state information of users and subsystems and/or components of E-CIU, and generates cooperative technical solutions based on cloud computing, including cooperative sensing, cooperative prediction, cooperative planning and decision making and cooperative control technologies.

The event model generates vehicle trajectory through the cloud computing module and AIaaS.

In some embodiments, the AIaaS provides an AI foundation model framework, which comprises an AI platform and an AI modeling framework. In some embodiments, the AI platforms are configured to conduct AI computing based on road, vehicle, cloud, and/or combination of each other under different spatial dimensions and temporal dimensions.

In some embodiments, the AI computing is conducted to provide the following, including but not limited to:
(a) traffic fence; (b) event data processing; (c) automated driving functions; (d) information services; (e) eight functions.

In some embodiments, the E-CIU provides foundation and architecture design for AI computing platform based on the Vehicle-Road-Cloud system, the Vehicle-Edge-Cloud system, or the Vehicle-Cloud system.

In some embodiments, the E-CIU provides allocation method and software for the AI computational loading and distribution among the vehicle component, the road component, and the cloud component of a Vehicle-Road-Cloud system, including intelligence allocation, function allocation, device allocation, resource allocation, and information allocation.

In some embodiments, the E-CIU provides allocation method and software for the AI computational loading and distribution among the vehicle component, the edge cloud component, and the central cloud component of a Vehicle-Edge-Cloud system, including intelligence allocation, function allocation, device allocation, resource allocation, and information allocation.

In some embodiments, the E-CIU provides allocation method and software for the AI computational loading and distribution among the vehicle component and the cloud component of a Vehicle Cloud system, including intelligence allocation, function allocation, device allocation, resource allocation, and information allocation.

In some embodiments, the AI modeling framework is configured for automated driving functions and services based on vehicles, roads, clouds, centers and/or different combinations of them under different spatial and temporal dimensions.

In some embodiments, the AI modeling framework comprises an AI model, data integration, a modeling platform, and all types of simulation, and/or optimization and evaluation.

In some embodiments, the AI model is configured for application in sensing, localization, data fusion, prediction, planning, decision-making, control, integration and/or allocation in automated driving tasks.

In some embodiments, the AI model comprises one or more of traditional AI model, digital twin and generative AI model, and multi-task AI model.

In some embodiments, the combination of the E-CIU system architecture, AI computing platform and/or AI modeling framework can provide AI-empowered connected mobility solutions.

In some embodiments, the connected mobility solutions achieve mobility by embedding large-scale AI modeling framework.

In some embodiments, the connected mobility solutions support better cloud service of a VRC system or a VC system with intelligence allocation.

In some embodiments, the connected mobility solutions realize one or more of automated driving service, transportation service, and logistics delivery service through the large-scale AI modeling framework.

In some embodiments, the multi-engine module is configured as a sensing engine, prediction engine, decision-making and planning engine, control engine, execution engine, operations engine, maintenance engine, and/or supporting engine.

In some embodiments, a sensing engine provides physical sensing and/or virtual sensing. In some embodiments, a sensing engine is configured to achieve a certain accuracy of the sensing fusion.

In some embodiments, the prediction engine conducts prediction at a microscopic level, a mesoscopic level, and/or a macroscopic level. In some embodiments, a prediction engine is configured to predict vehicle position, speed, acceleration, steering angle.

In some embodiments, the decision making and planning engine conducts decision-making and route planning at a microscopic level, a mesoscopic level, and/or a macroscopic level. In some embodiments, the decision-making and planning engine is configured to calculate vehicle drivable area and path planning.

In some embodiments, a control engine provides longitudinal and lateral control instructions at a microscopic level, a mesoscopic level, and/or a macroscopic level.

In some embodiments, the execution engine provides allocation and integration functions. In some embodiments, the execution engine is configured to realize the intelligent allocation of CAV and CAH equipment and functions. In some embodiments, the execution engine is configured to realize the system resource management and deployment.

In some embodiments, the operations engine is configured to monitor the operation status of a CAVH or an ADS. In some embodiments, the operation engine is configured to analyze emergencies and troubleshoot, etc.

In some embodiments, a maintenance engine is configured to respond and rescue for traffic accidents. In some embodiments, a maintenance engine is configured to maintain system infrastructure damage.

In some embodiments, the supporting engine is configured to support the entire operation process of the E-CIU, including upgrading the software and hardware, guaranteeing the power supply, and/or communication and information security.

In some embodiments, the execution of the collaborative operation between the CAV subsystems and the CAH subsystems is real-time interaction and communication among E-CIU, vehicles, and roads.

In some embodiments, the users of the method of collaborative operation between CAV subsystems and CAH subsystems include autonomous driving operation companies, car companies, cloud service providers, road and bridge companies, and/or technology companies.

In some embodiments, the collaborative operation between CAV subsystems and CAH and/or CAR subsystems collects data during execution of vehicle operational functions, including direct perception data, indirect perception data, prediction data, planning decision data, and/or control data.

In some embodiments, the direct perception data includes vehicle perception data, roadside perception data, and/or cloud perception data.

In some embodiments, the indirect perception information includes vehicle motion data obtained through satellite positioning perception and vehicle operating environment data.

In some embodiments, the E-CIU is configured to provide one or more of eight functions to vehicles, including enhancement, complement, backup, elevation, replacement, monitoring, operation, and maintenance.

In some embodiments, the enhancement function is configured to enhance the corresponding functions of vehicles when one or more of the sensing, prediction, decision-making and planning, control, operation and maintenance, management, service, and/or other functions cannot meet the requirements of safe operations.

In some embodiments, the complement function is configured to complement the missing functions of the vehicles when one or more of the sensing, prediction, decision-making and planning, control, operation and maintenance, management, service, and/or other functions of vehicles are missing.

In some embodiments, the backup function is configured to backup data and functions of vehicles when one or more of the sensing, prediction, decision-making and planning, control, operation and maintenance, management, service, and/or other functions of vehicles fail. The multiple-engine modules can ensure the normal operation of the vehicles through the backup data and functions.

In some embodiments, the elevation function is configured to elevate the intelligence level of the vehicles, including device elevation and functional elevation, wherein:
The device elevation is configured to provide computing power and storage capacity for the system through multiple engine modules and cloud computing modules, in order to elevate the computing power and storage capacity of the vehicles;
The functional elevation is configured to provide collaborative work of one or more of the sensing subsystem, prediction subsystem, decision making and planning subsystem, control subsystem, integration and allocation subsystem, service and management subsystem, and support subsystem to elevate the vehicle's function, including prediction ability, decision making and planning ability, control ability, etc.

In some embodiments, the replacement function is configured to provide device replacement and function replacement as below.

The equipment replacement provides information of malfunctioning equipment through the E-CIU and the replaceable equipment is provided by the support subsystem.

The function replacement determines the non-performing function through the E-CIU, wherein the non-performing function includes sensing, prediction, decision-making and planning, control, service, management, operation, and maintenance. The function replacement support is provided by the support module and is implemented by the service module.

In some embodiments, the monitoring function is configured to enable the E-CIU to monitor all traffic participants related to automated driving in all-road networks, all light conditions, all-weather conditions, and all life cycle, including driver status, environmental status, vehicle status, and automated driving system status. The monitoring function is configured to collect data from monitoring objects through the E-CIU.

In some embodiments, the support subsystem of the E-CIU is configured to provide backup, cloud computing, information security support for monitoring data, and to provide relevant data support to the service module group and management module group. Herein said driver status includes the physiological and psychological status of drivers, including but not limited to gender, age, distraction, drowsiness, alcohol consumption, and hyperactivity; said environmental status includes environmental conditions during the trip, e.g. road, weather, events, construction, accidents, and traffic status; said vehicle status includes the status of software and hardware, including vehicle dynamics (lateral motion, longitudinal motion), automated driving status (sensing, prediction, decision-making related software and hardware status), hardware status (engine, brake, steering wheel), and other software and hardware status (lighting, signal, vehicle machine); said automated driving system status includes the status of the automated driving highway system, the vehicle operation and maintenance system, and the cloud system.

In some embodiments, the operation functions are configured to provide device operation and function operation. The E-CIU provides more stable and reliable computing power and storage space for the vehicles through one or more subsystems and/or modules. Said computing power and storage space are configured to maintain one or more related hardware devices and functions operating normally during operation and maintenance. Herein the operation includes the sensing, prediction, decision-making and planning, control, service, and management of the vehicles; herein the device operation is configured to maintain the normal operation of vehicle's hardware devices related to sensing, prediction, decision-making and planning, control, operation and maintenance, management, and service. Such device includes storage devices, computing devices, and battery packs. Herein said functional operation is configured to maintain the normal operation of vehicles' sensing, prediction, decision-making and planning, control, operation and maintenance, management, and service functions.

In some embodiments, the maintenance functions are configured to provide equipment maintenance and functional maintenance. The E-CIU provides the capability to interact with external systems for the vehicles through one or more subsystems and/or modules. This interaction is used to promptly receive maintenance requests based on abnormal monitoring statuses from subsystems and/or modules of the E-CIU. The E-CIU provides the maintenance service for the vehicles in response to maintenance requests through the maintenance module. The equipment maintenance is configured for the maintenance and repair of vehicle's hardware equipment related to sensing, prediction, decision-making and planning, control, operation, management, and service. The functional maintenance is configured for the maintenance of vehicles' sensing, prediction, decision-making and planning, control, operation and maintenance, management, and service functions.

In some embodiments, the execution of the cooperative operation is the real-time interaction and communication among E-CIU, CAVs, and/or CAHs or CARs.

In some embodiments, the cooperative operation is configured to provide functions for CAVs to achieve automated driving tasks. In some embodiments, the E-CIU is configured to provide functions to elevate the intelligence level of CAVs.

In some embodiments, both E-CIU and CAR are configured to provide functions to elevate the intelligence level of CAVs. It follows that:

$${CAV}_{s} = f ( E - CIU , CAR , {CAV}_{o} ) or$$

$${CAV}_{s} = f ( E - CIU , {CAV}_{o} )$$

where CAVₒ represents the original operational intelligence level of the vehicle, CAVs represents the elevated intelligence level of the vehicle after being empowered by the E-CIU and/or CAR.

### Example

The following are examples of hardware and parameters that form embodiments of the claimed systems. Exemplary hardware and parameters that find use in the E-CIU include, but are not limited to, the following:

Storage devices:
Local storage device:
Hybrid Hard Drive (HDD): Western Digital (WD) Blue, Seagate BarraCuda, Toshiba P300, Western Digital (WD) Black, Seagate BarraCuda Pro, Toshiba X300.
Solid State Drive (SSD): Samsung 860 EVO, Crucial MX500, Kingston A400, Samsung 970 EVO NVMe, Western Digital (WD) Black SN750 NVMe, Corsair Force Series MP510
Memory card (MMC): SanDisk Ultra SDXC UHS-I, Kingston Canvas Select Plus SD/microSD, PNY Elite Performance SDXC UHS-I, SanDisk Extreme PRO SDXC UHS-I, Lexar Professional 2000x SDHC/SDXC UHS-II

Cloud storage device:
Object Storage: DigitalOcean Spaces, Wasabi Hot Cloud Storage, Backblaze B2 Cloud Storage, Amazon S3, Google Cloud Storage, Microsoft Azure Blob Storage
Block Storage: DigitalOcean Block Storage, Linode Block Storage, Vultr Block Storage, Amazon Elastic Block Store (EBS), Google Persistent Disk, Microsoft Azure Disk Storage
File Storage: NetApp Cloud Volumes ONTAP, Zadara VPSA, SoftNAS Cloud NAS, Amazon Elastic File System (EFS), Google Cloud Filestore, Microsoft Azure File Shares
Cold/Archival Storage: Backblaze B2 Cold Storage, Wasabi Cold Cloud Storage, Oracle Archive Storage, Amazon S3 Glacier, Google Cloud Storage Coldline, Microsoft Azure Blob Storage Archive Tier
Hybrid Cloud Storage: QNAP HybridMount, Synology Hybrid Share, Morro Data CloudNAS, NetApp Cloud Volumes Hybrid, Dell EMC Cloud Storage Services, HPE Cloud Volumes
Database Storage: DigitalOcean Managed Databases, Aiven Database-as-a-Service, ScaleGrid Database Hosting, Amazon RDS (Relational Database Service), Google Cloud SQL, Microsoft Azure SQL Database

Computing devices:
CPU: Intel Xeon E-2288G, AMD Ryzen Threadripper 3970X, Arm Cortex-A78, Intel Xeon Scalable Platinum 8280, AMD EPYC 7742, Arm Neoverse N1
GPU: NVIDIA T4 Tensor Core, NVIDIA Geforce RTX 3080, AMD Radeon Instinct MI50, NVIDIA A100 Tensor Core, NVIDIA V100 Tensor Core, AMD Instinct MI100, NVIDIA Drive AGX Xavier, Mobileye EyeQ5, Qualcomm Snapdragon Ride Platform
RAM: Kingston DDR4 32 GB 2400 MHz DIMM, Corsair Vengeance LPX DDR4 16 GB 3200 MHZ, Crucial DDR4 16 GB 2666 MHz DIMM, Samsung DDR4 128 GB 2933 MHz LRDIMM, Hynix DDR4 64 GB 3200 MHZ RDIMM, Micron DDR4 64 GB 2666 MHZ RDIMM
ROM: Kingston A2000 1 TB NVMe SSD, Crucial P1 1 TB NVMe SSD, SanDisk Ultra 3D NAND 2 TB SATA SSD, Samsung 970 EVO Plus 2 TB NVMe SSD, Intel Optane DC P4800X Series 750 GB SSD, Western Digital (WD) Black SN750 NVMe 2 TB SSD

Communication devices:
Ethernet: Netgear ProSAFE, TP-Link JetStream, D-Link DGS, Cisco Catalyst 9000, Juniper EX Series, Arista 7050X.
4G: TP-Link Archer MR600, D-Link DWR-921, Netgear LB2120, Nighthawk M1, ZTE MF288, Sierra Wireless AirLink MG90.
5G: Nokia FastMile 5G Gateway, TP-Link Archer MR5000, D-Link DWR-2010, Nighthawk M5, ZTE MC801, Ericsson 5G Radio Dot
Starlink: Starlink Dish, Starlink WiFi Router.
WiFi: TP-Link Archer C7, Netgear R6700, D-Link DIR-867, Asus RT-AX88U, Netgear Nighthawk AX12, Linksys Velop MX10.
Bluetooth: Anker Soundcore Life Q20, JLab Audio Go Air, Taotronics SoundLiberty 79, Sena 50S, Jabra Elite 75t, Sony WH-1000XM4
DSRC: Cohda Wireless MK5, Savari MobiWAVE 2000, Autotalks CRATON2
C-V2X: Qualcomm 9150 C-V2X Chipset, Autotalks PLUTON2, Savari StreetWAVE 2000

Supporting devices:
Rechargeable battery: Duracell Rechargeable AA, Energizer Recharge Universal, Panasonic Eneloop, Tesla Powerwall, LG Chem RESU, BYD B-Box
Emergency battery: APC Back-UPS Pro, Eaton 5S, CyberPower Intelligent LCD, APC Smart-UPS RT, Eaton 9PX, CyberPower Smart App Online

Exemplary parameters that find use in the AI modeling framework provided by the E-CIU include, but are not limited to, the following:

Traditional AI Models:
Machine Learning
Neural Networks
Deep Learning.
Deep Reinforcement Learning
Transformer

Digital Twin and Generative AI Models:
Vision Models: VAE, Flow-based, GAN, Diffusion, GPT, Sora
Natural Language Models: GPT, Large Language Models

Multi-Tasking Models:
Multi-Task Learning
Transfer Learning

Different intelligence levels of the overall system can be achieved with the allocation of intelligence among CAVs, CAHs or CARs, and cloud by utilizing the AI modeling framework. In some embodiments, when the intelligence level of the entire system is 2, the AI modeling framework allocates CAVs with an intelligence level of 2, CAHs or CARs with an intelligence level of 0, and Cloud with an intelligence level of 2 to achieve automated driving tasks. Said AI modeling framework can comprise LLM, VLM, MLM.

All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in the art are intended to be within the scope of the following claims.

1-93. (canceled)

94. An enterprise-oriented cloud control system (E-CCS), comprising:
an enterprise-oriented cloud intelligent unit (E-CIU) comprising a service and management subsystem, a communication subsystem, a sensing subsystem, a prediction subsystem, a planning and decision-making subsystem, a control subsystem, an integration and allocation subsystem, and a supporting subsystem, wherein:
a) said E-CIU is configured to provide automated driving services to an autonomous vehicle (AV), thereby providing automated driving functions to the AV for long-tail corner cases classified using a traffic fence based on multi-source input data; and
b) said E-CIU is configured to provide detailed and time-sensitive vehicle-specific control instructions to the AV, wherein said control instructions provide instructions for longitudinal and lateral position, speed, acceleration, and steering.

95. The E-CCS of claim 94, wherein said automated driving functions comprise one or more of a sensing function, a prediction function, a planning and decision-making function, a control function, a service function, a management function, an operation function, and a maintenance function.

96. The E-CCS of claim 94, wherein said traffic fence classifies automated driving scenarios based on a demand characteristic of an automated driving system (ADS) and a supply characteristic of the ADS, wherein:
a) said demand characteristic is an automated driving request generated by a user of the ADS; and
b) said supply characteristic is a sensing function, a computation function, a storage function, or a communication function provided by an E-CIU subsystem that is the service and management subsystem, the communication subsystem, the sensing subsystem, the prediction subsystem, the planning and decision-making subsystem, the control subsystem, the integration and allocation subsystem, or the supporting subsystem.

97. The E-CCS of claim 94, wherein said multi-source input data comprises an event data and/or a non-event data obtained from one or more of vehicles, roads, clouds, and centers, wherein:
a) said event data comprises one or more of work zone data, weather data, traffic control devices data, incident data, special event data, activity data, and near miss data; and
b) said non event data comprises one or more of traffic flow data, vehicle dynamics data, travel demand data, and system calculation and storage resource data.

98. The E-CCS of claim 94, wherein said E-CIU is configured to provide one or more information services selected from storage as a service (STaaS), control as a service (CCaaS), computing as a service (CaaS), information as a service (IaaS), sensing as a service (SEaaS), operation and maintenance as a service (OmaaS), and Artificial Intelligence as a service (AIaaS),
wherein said AIaaS is configured to provide:
a) one or more of an automated driving database, AI model training and download, and an AI foundation model framework to provide AI computing services; and
b) a combined solution of subsystems and/or components of the E-CIU to satisfy the demand of the ADS.

99. The E-CCS of claim 94, wherein said E-CIU is configured to provide detailed and customized control instructions for the AV in long-tail corner cases using an event model to support the user to solve long-tail scenario problems.

100. The E-CIU of claim 99, wherein said event model is configured to access one or more event data through the communication subsystem, use the event data as an input, convert a macroscopic event data into a microscopic event data, and optimize management and control for the AV.

101. The E-CIU of claim 99, wherein the event model is configured to perform a method comprising:
a) receiving sensing information from vehicles, roads, and clouds; receiving historical and/or real-time monitoring data from a traffic management center and/or a meteorological department; and extracting event data to provide an input;
b) analyzing the event data to identify function and demand changes for the sensing function, the prediction function, the planning and decision making function, and the control function;
c) obtaining function, resource, and state information of a user and/or a component of the E-CIU; and generating a cooperative technical solution based on centralized and/or distributed cloud computing, comprising one or more of cooperative sensing, cooperative prediction, cooperative planning and decision-making, and cooperative control technologies; and
d) generating detailed and time-sensitive vehicle-specific control instructions.

102. An enterprise-oriented cloud control system (E-CCS), comprising:
an enterprise-oriented cloud intelligent unit (E-CIU) comprising a service and management subsystem, a communication subsystem, a sensing subsystem, a prediction subsystem, a planning and decision-making subsystem, a control subsystem, an integration and allocation subsystem, and a supporting subsystem, wherein:
a) said E-CIU is configured to provide automated driving services for long-tail corner cases classified by a traffic fence based on multi-source input data to an autonomous vehicle (AV); and
b) said E-CIU is configured to provide vehicle-specific guidance information for the AV, thereby providing automated driving functions to the AV, wherein said vehicle-specific guidance information comprises one or more of sensing information, prediction information, planning and decision-making information, and route guidance information.

103. The E-CCS of claim 102, wherein said multi-source input data comprises an event data and/or a non-event data obtained from one or more of vehicles, roads, clouds, and centers, wherein:
a) said event data comprises one or more of work zone data, weather data, traffic control devices data, incident data, special event data, activity data, and near miss data; and
b) said non-event data comprises one or more of traffic flow data, vehicle dynamics data, travel demand data, and system calculation and storage resource data.

104. The E-CCS of claim 102, wherein said E-CIU is configured to provide one or more information services selected from storage as a service (STaaS), control as a service (CCaaS), computing as a service (CaaS), information as a service (IaaS), sensing as a service (SEaaS), operation and maintenance as a service (OmaaS) and Artificial Intelligence as a service (AIaaS),
wherein said AIaaS is configured to provide:
a) one or more of an automated driving database, AI model training and download, and an AI foundation model framework to provide AI computing services; and
b) a combined solution of subsystems and/or components of the E-CIU to satisfy the demand for automated driving services.

105. The E-CCS of claim 102, wherein said E-CIU is configured to provide vehicle-specific guidance information to the AV in long-tail corner cases using an event model to support the user to solve long-tail scenario problems.

106. The E-CIU of claim 105, wherein said event model is configured to access one or more event data through the communication subsystem, use the event data as an input, convert a macroscopic event data into a microscopic event data, and optimize management and guidance for the AV.

107. The E-CIU of claim 105, wherein the event model is configured to perform a method comprising:
a) receiving sensing information from vehicles, roads, and clouds; receiving historical and/or real-time monitoring data from a traffic management center and/or a meteorological department; and extracting event data to provide an input;
b) analyzing the event data to identify function and demand changes for the sensing function, the prediction function, the planning and decision-making function, and the control function;
c) obtaining function, resource, and state information of a user and/or a component of the E-CIU; and generating a cooperative technical solution based on centralized and/or distributed cloud computing, comprising one or more of cooperative sensing, cooperative prediction, cooperative planning and decision-making, and cooperative control technologies; and
d) generating vehicle-specific guidance information.

108. An enterprise-oriented cloud control system (E-CCS), comprising:
an enterprise-oriented cloud intelligent unit (E-CIU) providing detailed and time-sensitive vehicle-specific control instructions to an autonomous vehicle (AV), and providing the AV with automated driving services for long-tail corner cases classified by a traffic fence based on multi-source input data; and
an OBU comprising a vehicle control module controlling the AV according to said control instructions,
wherein:
a) said E-CIU comprises a service and management subsystem, a communication subsystem, a sensing subsystem, a prediction subsystem, a planning and decision making subsystem, a control subsystem, an integration and allocation subsystem, and a supporting subsystem; and
b) said OBU comprises an OBU communication module communicating with said E-CIU, receiving vehicle-specific control instructions from said E-CIU, and sending vehicle-specific information and driving information to said E-CIU; and
c) wherein said vehicle-specific control instructions comprise instructions for longitudinal and lateral position, speed, acceleration, and steering.

109. The E-CCS of claim 108, wherein said E-CIU is configured to provide one or more information services selected from storage as a service (STaaS), control as a service (CCaaS), computing as a service (CaaS), information as a service (IaaS), sensing as a service (SEaaS), operation and maintenance as a service (OmaaS) and Artificial Intelligence as a service (AIaaS),
wherein said AIaaS is configured to provide:
a) one or more of an automated driving database, AI model training and download, and an AI foundation model framework to provide AI computing services; and
b) a combined solution of subsystems and/or components of the E-CIU to satisfy the demand of automated driving service.

110. The E-CCS of claim 108, wherein said E-CIU is configured to provide detailed and customized control instructions for the AV in long-tail corner cases using an event model to support the user to solve long-tail scenario problems.

111. The E-CIU of claim 110, wherein said event model is configured to access one or more event data through the communication subsystem, use the event data as an input, convert a macroscopic event data into a microscopic event data, and optimize management and control for the AV.

112. The E-CIU of claim 110, wherein the event model is configured to perform a method comprising:
a) receiving sensing information from vehicles, roads, and clouds; receiving historical and/or real-time monitoring data from a traffic management center and/or a meteorological department; and extracting event data to provide an input;
b) analyzing the event data to identify function and demand changes for the sensing function, the prediction function, the planning and decision-making function, and the control function;
c) obtaining function, resource, and state information of a user and/or a component of the E-CIU; and generating a cooperative technical solution based on centralized and/or distributed cloud computing, comprising one or more of cooperative sensing, cooperative prediction, cooperative planning and decision-making, and cooperative control technologies; and
d) generating detailed and time-sensitive vehicle-specific control instructions.

113. The E-CCS of claim 108, wherein said E-CIU is configured to send detailed and time-sensitive vehicle-specific control instructions for the AV to enter a fully controlled system; and to assume control of the AV by the vehicle control module of the AV.
